(19) United States
(12) Patent Application Publication
(10) Pub. No.: US 2025/0070955 A1
(43) Pub. Date: Feb. 27, 2025

(54) INFORMATION PROCESSING APPARATUS, METHOD, AND NON-TRANSITORY COMPUTER READABLE MEDIUM

(71) Applicant: NEC Corporation, Tokyo (JP)

(72) Inventor: Kazuhiko MINEMATSU, Tokyo (JP)

(73) Assignee: NEC Corporation, Tokyo (JP)

(21) Appl. No.: 18/799,178

(22) Filed: Aug. 9, 2024

(30) Foreign Application Priority Data
Aug. 23, 2023 (JP) 2023-135348

(51) Int. Cl. H04L 9/06; H04L 9/08

(52) U.S. Cl. CPC H04L 9/0618; H04L 9/0869

(57) ABSTRACT

An information processing apparatus includes a concatenation unit, a concatenation information generation unit, and a tag generation unit. The concatenation unit generates concatenation data obtained by concatenating a plurality of elements of input data consisting of the plurality of elements with one another. The concatenation information generation unit generates, for each of a plurality of message blocks obtained by dividing the concatenation data into blocks each having a predetermined data length, concatenation information about the concatenation of the elements in the message block. The tag generation unit generates a tag for a message authentication code by a block cipher by using each of the plurality of message blocks and each of the concatenation information corresponding to the respective message blocks, the block cipher being a cipher of which an input is a message having the predetermined data length.

### INCORPORATION BY REFERENCE

This application is based upon and claims the benefit of priority from Japanese patent application No. 2023-135348, filed on Aug. 23, 2023, the disclosure of which is incorporated herein in its entirety by reference.

### TECHNICAL FIELD

The present disclosure relates to an information processing apparatus, a method, and a non-transitory computer readable medium.

### BACKGROUND ART

A technology for a message authentication code (Message Authentication Code: MAC), in which tampering with a message is detected by using a private key shared in advance, has been known. It is possible to detect unauthorized tampering with a message by applying a message authentication code to a communication channel. Data of such a message authentication code used to detect tampering with a message is also called a tag (an authentication tag or a validation tag). Examples of technologies related to a message authentication code include those disclosed in Non-patent Literature 1, Non-patent Literature 2, and Non-patent Literature 3.

Non-patent Literature 1 discloses a technology related to a message authentication code of which an input is a vector consisting of a plurality of elements. Non-patent Literature 2 discloses a technology in which a Tweakable block cipher (Tweakable block cipher; TBC) in which an auxiliary variable (adjustment value) called a Tweak is introduced is implemented by an XEX mode using a block cipher. Non-patent Literature 3 discloses a technology called LAPMAC (Lightweight Alternative to PMAC) which is an improved version of a PMAC (Parallelizable MAC) which is a parallelizable message authentication code based on a block cipher. Further, Non-patent Literature 4 discloses a technology for implementing a Tweakable block cipher.

Non-patent Literature 1: Phillip Rogaway and Thomas Shrimpton, “Deterministic Authenticated-Encryption: A Provable-Security Treatment of the Key-Wrap Problem”, Aug. 20, 2007, https://eprint.iacr.org/2006/221 Non-patent Literature 2: Philip Rogaway, “Efficient Instantiations of Tweakable Blockciphers and Refinements to Modes OCB and PMAC”, Sep. 24, 2004, https://www.cs.ucdavis.edu/˜rogaway/papers/offsets.pdf Non-patent Literature 3: Kazuhiko Minematsu, “A Lightweight Alternative to PMAC”, SAC 2019, 10 Jan. 2020, https://link.springer.com/chapter/10.1007/978-3-030-38471-5_16 Non-patent Literature 4: Christof Beierle, Jeremy Jean, Stefan Kolbl, Gregor Leander, Amir Moradi, Thomas Peyrin, Yu Sasaki, Pascal Sasdrich, and Siang Meng Sim, “The SKINNY Family of Block Ciphers and its Low-Latency Variant MANTIS”, Crypto 2016, https://eprint.iacr.org/2016/660.pdf

In the technology disclosed in Non-patent Literature 1, a tag of a message authentication code can be efficiently generated when the number of elements and the length of each of the elements of input data, which consists of a plurality of elements, are limited under certain conditions. However, in the technology disclosed in Non-patent Literature 1, there is a possibility that a tag of a message authentication code may not be efficiently generated depending on the number of elements and the length of each element. Therefore, it is desirable to efficiently generate a tag even when the number of elements and the length of each element are variable.

### SUMMARY

The present disclosure has been made to solve the above-described problem, and an object thereof is to provide an information processing apparatus, a method, and a program capable of efficiently generating a tag irrespective of the number of elements and the length of each element.

An information processing apparatus according to the present disclosure includes: concatenation means for generating concatenation data obtained by concatenating a plurality of elements of input data consisting of the plurality of elements with one another; concatenation information generation means for generating, for each of a plurality of message blocks obtained by dividing the concatenation data into blocks each having a predetermined data length, concatenation information about the concatenation of the elements in the message block; and tag generation means for generating a tag for a message authentication code by a block cipher by using each of the plurality of message blocks and each of the concatenation information corresponding to the respective message blocks, the block cipher being a cipher of which an input is a message having the predetermined data length.

An information processing method according to the present disclosure includes: generating concatenation data obtained by concatenating a plurality of elements of input data consisting of the plurality of elements with one another; generating, for each of a plurality of message blocks obtained by dividing the concatenation data into blocks each having a predetermined data length, concatenation information about the concatenation of the elements in the message block; and generating a tag for a message authentication code by a block cipher by using each of the plurality of message blocks and each of the concatenation information corresponding to the respective message blocks, the block cipher being a cipher of which an input is a message having the predetermined data length.

A program according to the present disclosure causes a computer to perform: a step of generating concatenation data obtained by concatenating a plurality of elements of input data consisting of the plurality of elements with one another; a step of concatenation information generation means for generating, for each of a plurality of message blocks obtained by dividing the concatenation data into blocks each having a predetermined data length, concatenation information about the concatenation of the elements in the message block; and a step of tag generation means for generating a tag for a message authentication code by a block cipher by using each of the plurality of message blocks and each of the concatenation information corresponding to the respective message blocks, the block cipher being a cipher of which an input is a message having the predetermined data length.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram for explaining a message authentication code according to the present disclosure;

FIG. 2 is a diagram for explaining a CMAC;

FIG. 3 is a diagram for explaining an example of a vector-input MAC;

FIG. 4 shows a configuration of an authentication system according to the present disclosure;

FIG. 5 shows an example of a configuration of a tag generation apparatus according to the present disclosure;

FIG. 6 is a diagram for explaining an example of concatenation information according to the present disclosure;

FIG. 7 is a diagram for explaining an example of concatenation information according to the present disclosure;

FIG. 8 is a diagram for explaining an outline of an operation performed by a tag generation unit according to the present disclosure;

FIG. 9 is a diagram for explaining an outline of an operation performed by the tag generation unit according to the present disclosure;

FIG. 10 is a diagram for explaining an outline of an operation performed by the tag generation unit according to the present disclosure;

FIG. 11 is a diagram for explaining an outline of an operation performed by the tag generation unit according to the present disclosure;

FIG. 12 shows an example of a configuration of a tag verification apparatus according to the present disclosure;

FIG. 13 is a flowchart showing a tag generation method performed by a tag generation apparatus according to the present disclosure;

FIG. 14 is a flowchart showing a tag verification method performed by a tag verification apparatus according to the present disclosure;

FIG. 15 shows a configuration of an information processing apparatus according to the present disclosure;

FIG. 16 is a flowchart showing an information processing method implemented by an information processing apparatus according to the present disclosure; and

FIG. 17 is a block diagram schematically showing an example of a hardware configuration of a calculation processing apparatus capable of implementing an apparatus and a system according to the present disclosure.

### EXAMPLE EMBODIMENT

### Outline of Example Embodiment

Prior to describing an example embodiment, an outline of an example embodiment will be described. Note that although example embodiments will be described hereinafter, the following example embodiments are not intended to limit the invention specified by the claims. Further, not all combinations of features described in the example embodiments are essential for the means for solving the invention. Further, indices (alphabet) used in the following description may not be common throughout this specification. For example, an index i in one context and another index i in another context may refer to elements or the like different from each other. Further, it should be noted that although example embodiments are described by using the drawings, each of the drawings used in the description of a respective one of the example embodiments do not necessarily apply only to that example embodiment. That is, each of the drawings may apply to any of the example embodiments.

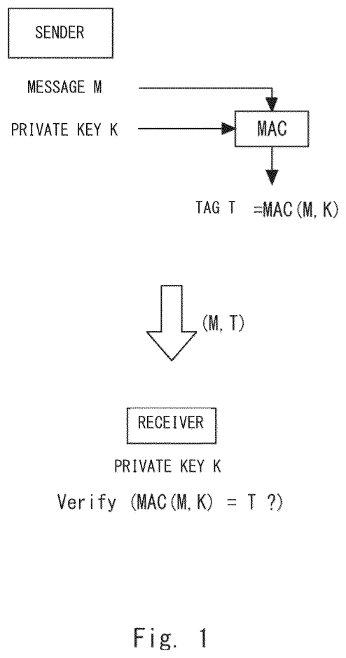

FIG. 1 is a diagram for explaining a message authentication code according to the present disclosure. In the example shown in FIG. 1, a sender and a receiver share a private key K (i.e., possess the same private key K), and the sender transmits a message M to the receiver. Note that examples of MAC include, but are not limited to, a CMAC (Cipher-based MAC), an HMAC (Hash-based MAC), a GMAC (Galois MAC), and a PMAC.

Processing performed on the sender side will be described. The sender performs processing expressed as T=MAC(M, K). Note that the function MAC(M, K) is a function for outputting a tag T based on an input message M by using a private key K as a parameter. Note that T is a fixed-length variable for detecting tampering, called a tag (authentication tag). The sender transmits a pair (M, T) consisting of a message M and a tag T to the receiver. Note that data X (i.e., message M) input to the MAC satisfies X∈{0, 1}\hat{ }*. Note that ‘*’ indicates an arbitrary number of bits, and “{0, 1}\hat{ }*” indicates a set of bit sequences (or bit series, bit strings, or bit streams) each having an arbitrary length (a space of * bits). Therefore, the data X to be input is arbitrary bit sequences which may include an empty sequence (or empty series, empty string, or empty stream) ε. Further, the output T of the MAC satisfies T∈{0, 1}\hat{ }τ. Note that τ indicates the number of bits having a fixed length (i.e., a fixed number of bits), and “{0, 1}\hat{ }τ” indicates a set of bit sequences each having a fixed length τ (a space of t bits). Therefore, T is a bit sequence having τ bits.

Next, processing performed on the receiver side will be described. Information received on the receiver side is expressed as (M′, T′). In this case, the receiver side performs a function MAC(M′, K) as a verification process. When no tampering has occurred during the communication, a relation MAC(M′, K)=T′=T holds. In this case, a relation (M′, T′)=(M, T) holds. In this case, the verification process succeeds. Therefore, it is authenticated that the tag T was generated by a person who legitimately knows about the private key K. On the other hand, when tampering has occurred during the communication, a relation MAC(M′, K)=T′≠T holds. In this case, a relation (M′, T′)≠(M, T) holds. In this case, the verification process does not succeed. Therefore, it is detected that tampering has occurred for the pair (M′, T′).

Note that when a tag is generated by the MAC, a block cipher (Block Cipher; BC) is used. In the block cipher, a fixed-length input/output keyed substitution is performed. That is, an encryption result having a fixed length is obtained by encrypting a message block having a fixed length (substitution) by a block cipher. When a cryptographic primitive (cryptopart; encrypting function) of the block cipher in which a key K is used as a parameter is represented by E_K; a plaintext message is represented by M; and a ciphertext is represented by C, their relation is expressed as E_K(M)=C.

Further, the block cipher may be one called a Tweakable block cipher (TBC: Tweakable Block Cipher) disclosed in Non-patent Literature 2, in which a public adjustment value (auxiliary variable) called a Tweak is introduced. In the TBC, a keyed substitution in which a Tweak is included in an input of the block cipher is performed. Further, TBCs of which the Tweaks are different from each other can be regarded as block ciphers independent of each other. That is, when the same messages as each other are processed by TBCs of which the Tweaks are different from each other, encryption results different from each other are obtained.

Note that when a Tweak is represented by Tw, the TBC function is expressed by the below-shown Expression 1.

$$[ Expression 1 ]$$

$${\tilde{E}}_{K}^{Tw} ( M ) = C \qquad ( 1 )$$

Note that in the following description, the left side (TBC function) of Expression 1 may be expressed as “E__{K}\hat{ }Tw^{˜}(M)” or “E_{K}^{Tw˜}(M)”, or simply as “EK^{˜}” or “E_K^{˜}”.

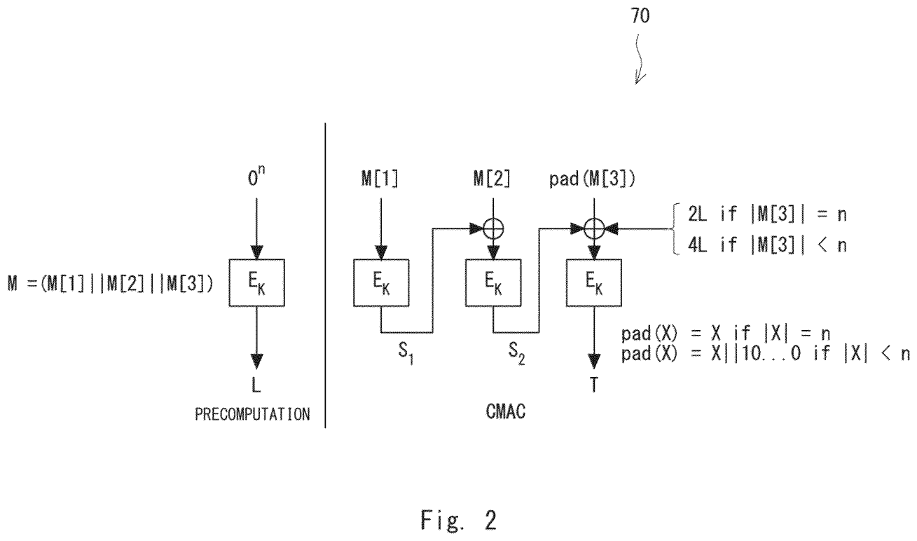

FIG. 2 is a diagram for explaining a CMAC. FIG. 2 shows an example of an outline of an operation related to a CMAC. Further, FIG. 2 shows an example in which a tag generation apparatus 70 according to a first comparative example performs an operation by a CMAC.

Note that in the CMAC shown in FIG. 2, an encryption function E_K is used as a cryptographic primitive (cryptopart). Note that the encryption function E_K processes a message block having a block size of n bits. That is, the encryption function E_K receives an n-bit message block as an input and outputs an n-bit encryption result. Note that n is, for example, but not limited to, 128 bits or 256 bits.

The tag generation apparatus 70 divides a message M into blocks each having a predetermined length. In the example shown in FIG. 2, the tag generation apparatus 70 divides the message M into message blocks M[1], M[2] and M[3], each of which is a n-bit bit sequence (i.e., a bit sequence consisting of n bits). That is, M is expressed as M=M[1]∥M[2]∥M[3]. Note that M[3] is the last message block. Note that “∥” indicates concatenation of bit sequences. Further, when the bit length (bit size) of a bit sequence x is represented by |x|, a relation |M[1]|=|M[2]|=n holds. Further, a relation |M[3]|≤n holds.

As precomputation, the tag generation apparatus 70 encrypts an initial value 0\hat{ }n by the encryption function E_K and thereby acquires a value L as the encryption result. Note that 0\hat{ }n indicates a bit sequence consisting n bits in which all the bits are zero. Further, the tag generation apparatus 70 encrypts the first message block M[1] by the encryption function E_K, and acquires a random number S_1 as the encryption result. The tag generation apparatus 70 encrypts a value obtained by the exclusive OR (XOR) of the random number S_1 and the second message block M[2] by the encryption function E_K, and acquires a random number S_2 as the encryption result.

The tag generation apparatus 70 performs a padding process such as a one-zero padding (ozp) process on the message block M[3], which is the last message block, and thereby acquires an n-bit bit sequence pad (M[3]) corresponding to the message block M[3]. Note that when |X|=n, a relation pad (X)=X holds. Further, when |X|<n, a relation pad (X)=X|10 . . . 0 holds.

The tag generation apparatus 70 encrypts a value obtained by the exclusive OR of the random number S_2, the bit sequence pad (M[3]), and a predetermined mask value by the encryption function E_K. The tag generation apparatus 70 acquires the encryption result obtained by this encryption as a tag T. Note that when |M[3]|=n, the predetermined mask value is, for example, 2 L. Further, when |M[3]|<n, the predetermined mask value is, for example, 4 L.

In the case where a tag is generated by the CMAC, when the number of message blocks is m, the number of calls to the encryption function E_K excluding those for the precomputation may be m. In the example shown in FIG. 2, the number of calls to the encryption function E_K is three times. That is, the number of calls to the encryption function E_K is expressed by the below-shown Expression 2. Note that ceil( ) represents a ceiling function.

$$[ Expression 2 ]$$

$$max \{ ceil ( \frac{\vert M \vert}{n} ) , 1 \} \qquad ( 2 )$$

It should be noted that even when the message M is an empty sequence, it is necessary to call the encryption function E_K once. Note that even when the tag is generated by the PMAC, the number of calls to the encryption function E_K excluding those for the precomputation may be m. When the number of calls to the encryption function E_K excluding the precomputation is expressed by Expression 2, the processing of the MAC can be considered to be “efficient”. That is, when the number of calls to the encryption function E_K is a number corresponding to the length of the message (i.e., when the number of calls to the encryption function E_K corresponds to the length of the message), the processing of the MAC can be considered to be “efficient”.

A MAC of which an input is data (data structure) consisting of a plurality of elements will be described hereinafter. The data consisting of a plurality of elements is, for example, but is not limited to, a vector. An example in which the data consisting of a plurality of elements is a vector will be described hereinafter. A vector is a list of arbitrary bit sequences. Note that a vector may include an empty sequence. For example, the vector V expressed as V=(ε, ε, 001) is a vector consisting of three elements. Further, a vector V′ expressed as V′=(001) is a vector consisting of one element. Therefore, V is not equal to V′ (V≠V′). That is, in a vector, an empty sequence is also a meaningful element. Therefore, V and V′ should be distinguished from each other as data input to the MAC.

Here, it is assumed that a single bit sequence corresponding to a vector is input to the MAC. Assuming bit sequences each of which is obtained by simply concatenating the elements of a vector with one another, a vector V=(0,0) and a vector V′=(00) are not distinguished from each other. Therefore, in general, it is not secure to input a bit sequence that it obtained by simply concatenating the elements of a vector with one another into the MAC. Therefore, a vector-input MAC(Vector-Input MAC) can be implemented by a function encode (V) that uniquely encodes (converts) a vector V into a single bit sequence.

Here, assume that a vector V is expressed as V=(V[1], V[2], V[3]). An example of the encode (V) is an encode (V)=(V[1]∥len(V[1])∥V[2]∥len (V[2])∥V[3]∥len(V[3])). Note that “len(X)” is a fixed-length bit sequence indicating information about the length of a bit sequence X. Note that the bit length of len(X) is a length with which it is possible to express the bit length of the longest element of the vector. The function len( ) has a function for distinguishing elements from one another. That is, len( ) indicates at which position in a concatenated single bit sequence elements are concatenated. Therefore, by adding len( ) it is possible to generate, for a plurality of vectors that are different from each other when they are compared on an element-to-element basis, but their bit sequences obtained by simply concatenating their elements with one another are apparently identical to each other, tags different from each other.

Note that in the above-described method, since len( ) is added, the length of the data input to the MAC becomes longer than the sum total of the bit lengths of all the elements of the original vector by an amount expressed as |len( )|×(Number of elements). That is, when the message M is expressed as M=V[1]∥V[2]∥V[3], a relation |M|<|encode (V)| holds. Therefore, the number of calls to the encryption function E_K may be larger than the number shown by the above-shown Expression 2. That is, since the number of message blocks obtained by dividing the input message into the predetermined lengths increases, the number of calls to the encryption function E_K may increase. Therefore, the MAC in this method cannot be considered to be efficient. This fact becomes more remarkable when the number of elements of a vector is large and, in particular, when there are a lot of elements of which the lengths are short relative to the maximum bit length. Note that as described above, for example, although the CMAC makes it possible to implement an “efficient” bit sequence MAC, if the CMAC is applied to the vector-input MAC by the above-described method in which len( ) is added, the efficiency may deteriorate.

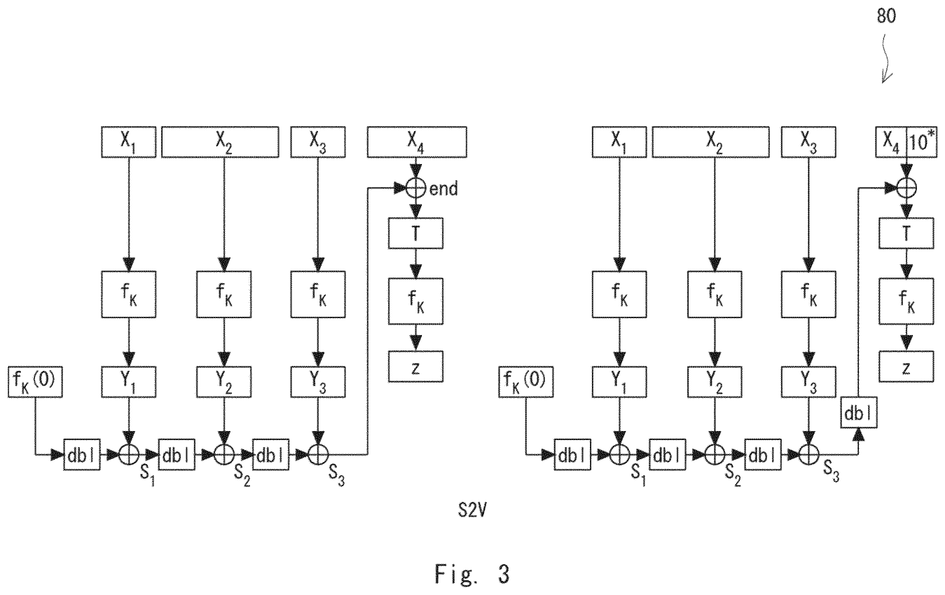

FIG. 3 is a diagram for explaining an example of a vector-input MAC. FIG. 3 schematically shows an example of an operation related to a vector-input MAC to which a CMAC is applied. Further, FIG. 3 shows an example in which a tag generation apparatus 80 according to a second comparative example performs an operation related to the vector-input MAC to which the CMAC is applied. Further, FIG. 3 shows an example in which the vector-input MAC is implemented by a method called S2V (String-to-Vector) disclosed in Non-patent Literature 1.

The tag generation apparatus 80 generates a tag by using a vector X=(X_1, X_2, X_3, X_4) as an input. Note that f_K is a function for implementing a bit sequence MAC by a CMAC using a key K as a parameter. Further, f_K receives a bit sequence {0, 1}\hat{ }* having an arbitrary length as an input and outputs a bit sequence {0, 1}\hat{ }n having a fixed length n. Further, f_K implements the MAC by a block cipher. That is, as shown in FIG. 2, f_K generates an n-bit random number by calling the encryption function E_K for each of m blocks obtained by dividing an input vector element V[k] into blocks each having n bits. It should be noted that in this case, the vector elements V[k] correspond to the message M shown in FIG. 2. Note that when the length of the vector element V[k] is not equal to a multiple of n, in the function f_K, for the last block, n-bit sequence data obtained by performing a padding process on the last block is input into the encryption function E_K.

The tag generation apparatus 80 inputs a bit sequence X_1 having an arbitrary length into f_K and thereby acquires an n-bit bit sequence Y_1. Similarly, the tag generation apparatus 80 inputs a bit sequence X_2 having an arbitrary length into f_K and thereby acquires an n-bit bit sequence Y_2. Further, the tag generation apparatus 80 inputs a bit sequence X_3 having an arbitrary length into f_K and thereby acquires a n-bit bit sequence Y_3. The tag generation apparatus 80 obtains a random number S_1 by the exclusive OR of a value obtained by performing a twofold multiplication on f_K(0) obtained by inputting an initial value 0\hat{ }n into f_K (i.e., a twofold multiplication on the finite field GF(2\hat{ }n)) and the bit sequence Y_1. The tag generation apparatus 80 obtains a random number S_2 by the exclusive OR of a value obtained by performing a twofold multiplication on the random number S_1 and the bit sequence Y_2. The tag generation apparatus 80 obtains a random number S_3 by the exclusive OR of a value obtained by performing a twofold multiplication on the random number S_2 and the bit sequence Y_3.

When the bit length of the last element X_4 is n bits or longer, the tag generation apparatus 80 obtains a tag T of which the number of bits is |X_4| by the exclusive OR of the random number S_3 and lower n bits of the bit sequence X_4 as shown in the left part of FIG. 3. When the bit length of the last element X_4 is shorter than n bits, the tag generation apparatus 80 performs a padding process on the bit sequence X_4 as shown in the right part of FIG. 3. The tag generation apparatus 80 obtains a tag T by the exclusive OR of an n-bit bit sequence X_4∥10\hat{ }* obtained by the above-described process and a value obtained by performing a twofold multiplication on the random number S_3. The tag generation apparatus 80 inputs the tag T into f_K and thereby acquires an n-bit random number Z.

Note that when the number of calls to the encryption function E_K is equal to a number corresponding to the total length of the elements of the vector in the processing of the vector-input MAC, the processing of the vector-input MAC can be considered to be efficient. In other words, when the number of calls to the encryption function E_K is equal to a number corresponding to the length of the bit sequence obtained by concatenating the elements of the vector with one another in the processing of the vector-input MAC, it is considered that the tag can be efficiently generated. However, in the second comparative example, there is a possibility that the processing of the MAC cannot be efficiently performed depending on the data structure of the vector. In other words, in the second comparative example, there is a possibility that a tag cannot be efficiently generated depending on the data structure of the vector.

Specifically, for example, assume a case where the number of elements of the vector V is n−1 and each of the elements is a 1-bit “0”, i.e., the vector Vis expressed as V=(0, 0, . . . , 0). In the second comparative example, as described above, when the length of an element of an input vector is not equal to a multiple of n in f_K, a padding process is performed so that the length of the element becomes a multiple of n bits. Then, in f_K, the encryption function E_K is called for the bit sequence having the length equal to a multiple of n bits obtained by the padding process. In this case, when the length of the bit sequence obtained by the padding process is expressed as n×m bits, the encryption function E_K is called m times in f_K. Therefore, in the second comparative example, in the above-described case, in one f_K, a padding process is performed and the encryption function E_K is called once for each of the elements each consisting of 1-bit “0”, and an n-bit bit sequence is thereby obtained. Therefore, in the second comparative example, in the above-described case, the encryption function E_K is called n−1 times, i.e., called the number of times corresponding to the number of elements, for the vector V. Further, in the above-described case, assume that V[1]∥V[2]∥ . . . ∥V[n−1] obtained by concatenating the elements of the vector V is processed. In this case, since the bit length of V[1]∥V[2]∥ . . . ∥V[n−1] is n−1 bits which is shorter than n, the encryption function E_K is called only once in f_K. Therefore, when the process of the MAC in the second comparative example is performed for the vector V in which each element is a 1-bit “0”, there is a possibility that the number of calls to the encryption function E_K becomes larger than the number corresponding to the total length of the elements of the vector. Therefore, in the second comparative example, when the length of the element is short as in the case of the vector V=(0, 0, . . . , 0), there is a possibility that the processing of the MAC cannot be efficiently performed.

Further, when the vector includes an element consisting of an empty sequence, the encryption function E_K needs to be called once for that element in the second comparative example. However, since the bit length of an element consisting of an empty sequence can be regarded as zero, it cannot be considered to be efficient to call the encryption function E_K once for the element consisting of an empty sequence. That is, in the second comparative example, when the vector includes an element consisting of an empty sequence, there is a possibility that the number of calls to the encryption function E_K becomes larger than the number of calls corresponding to the total length of the elements of the vector. Therefore, in the second comparative example, when the vector includes an element consisting of an empty sequence, there is a possibility that the processing of the MAC cannot be efficiently performed.

Note that for example, when the lengths of all the elements of the vector are a multiple of n and none of the elements is an empty sequence, the processing of the MAC can be efficiently performed even in the second comparative example. Further, when the lengths of all the elements of the vector are equal to each other, i.e., when the lengths of all the elements of the vector have a predetermined fixed length, it is possible to distinguish the elements of the vector from one another even in the bit sequence that is obtained by concatenating the elements of the vector with one another without adding the above-described len( ) Therefore, when the lengths of all the elements of the vector have a fixed length, it is possible to securely and efficiently perform the processing of the MAC even when the bit sequence that is obtained by concatenating the elements of the vector with one another is processed by the CMAC. However, in the above-described comparative example, if such constraints are not imposed on the elements of the input vector, there is a possibility that the processing of the MAC cannot be efficiently performed.

In contrast, as will be described below, in this example embodiment, the processing of the MAC can be efficiently performed on input data consisting of a plurality of elements owing to the configuration described below. That is, an apparatus according to this example embodiment generates concatenation data obtained by concatenating a plurality of elements of input data consisting of the plurality of elements with one another. Note that the “input data consisting of a plurality of elements” is, for example, but is not limited to, vector data consisting of a plurality of elements. The following descriptions will be given on the assumption that, as a general rule, input data is vector data.

Further, the apparatus according to this example embodiment generates, for each of a plurality of message blocks obtained by dividing concatenation data into blocks each having a predetermined data length, concatenation information (i.e., a piece of concatenation information) about the concatenation of the elements in the message block. Note that the “predetermined data length” corresponds to an input bit length (n bits) of a block cipher. The “concatenation information” indicates how elements are concatenated with one another in the corresponding message block. For example, the concatenation information may indicate at least a concatenation position of elements in each of a plurality of message blocks. Further, the concatenation information may indicate the position(s) of element(s) which is an empty sequence(s) and the number thereof in each of the plurality of message blocks. Further, the concatenation information may indicate at least a concatenation position of elements in each of positions at which elements can be concatenated with each other in each of the plurality of message blocks. Further, the concatenation information may indicate the concatenation information may indicate the position(s) of element(s) which is an empty sequence(s) and the number thereof in each of the plurality of message blocks in each of positions at which elements can be concatenated with each other in each of the plurality of message blocks. Details of these features will be described later.

Further, the apparatus according to this example embodiment generates a tag for a message authentication code by a block cipher by using each of the plurality of message blocks and each of the concatenation information (i.e., the pieces of concatenation information) corresponding to the respective message blocks. Further, the apparatus according to this example embodiment may generate a tag by generating a plurality of random numbers corresponding to the respective message blocks by a block cipher by using the concatenation information (i.e., the pieces of concatenation information) corresponding to the respective message blocks. Details of these features will be described later. Note that the “block cipher” may be, for example, an encryption method using the above-described encryption function E_K. Further, the “block cipher” may be the above-described block cipher called the Tweakable block cipher (TBC: Tweakable Block Cipher).

By the above-described configuration, in this example embodiment, it is possible to efficiently generate a tag irrespective of the number of elements and the length of each of the elements of input data. In other words, in this example embodiment, it is possible to efficiently generate a tag even when the number of elements and the length of each of the elements of input data are variable. That is, concatenation data and message blocks obtained by dividing this concatenation data in this example embodiment do not contain information for distinguishing elements from each other, such as the above-described len( ) Therefore, the length of concatenation data according to this example embodiment, i.e., the sum total of the lengths of a plurality of message blocks, corresponds to the sum total of the lengths of the bit sequences of all the elements of input data. Further, in the case where input data includes an element consisting of an empty sequence, when the length of the element consisting of an empty sequence is defined as zero bits, the element consisting of an empty sequence does not contribute to (i.e., does not affect) the concatenation data and the number of message blocks obtained by dividing this concatenation data in this example embodiment. These features hold true irrespective of the number of elements and the length of each of the elements of input data. In other words, the above-described features hold true even when no constraint is imposed on the number of elements and the length of each of the elements of input data.

Further, in this example embodiment, when a tag is generated by a block cipher using a plurality of message blocks, concatenation information (i.e., a plurality of pieces of concatenation information) corresponding to the respective message blocks is used. In this way, it is possible to generate, for a plurality of input data (input vectors) that are different from each other when they are compared on an element-to-element basis, but their bit sequences obtained by simply concatenating their elements with one another are apparently identical to each other, tags different from each other. For example, assume that there are two message blocks of which the data sequences are identical to each other, and while a first message block consists of one element, a second message block consists of two elements. In this case, concatenation information corresponding to the first message block is different from concatenation information corresponding to the second message block. Therefore, a random number obtained by a block cipher by using the concatenation information corresponding to the first message block may be different from a random number obtained by the block cipher by using the concatenation information corresponding to the second message block. In other words, a random number obtained by a block cipher by using the first message block and using the concatenation information corresponding thereto as a parameter may be different from a random number obtained by the block cipher by using the second message block and using the concatenation information corresponding thereto as a parameter. Therefore, a tag generated by using the first message block may be different from a tag generated by using the second message block. Therefore, the security in the vector-input MAC is ensured. In other words, the security in the vector-input MAC can be ensured without incorporating information such as len( ) into the message block. It should be noted that in this example embodiment, concatenation information itself is not encrypted by the block cipher. Therefore, in this example embodiment, it is possible to prevent the length of a message processed (encrypted) by a block cipher from becoming longer than the length of input data.

As described above, in this example embodiment, the number of calls to the block cipher can be made equal to the number corresponding to the total length of the elements of input data without compromising the security in the processing of the MAC irrespective of the number of elements and the length of each element. That is, in this example embodiment, except for the precomputation, the number of calls to the encryption function E_K in the processing of a vector V consisting of elements V[k] (k=1, . . . , r) by the MAC can be made equal to the number expressed by the below-shown Expression 3.

$$[ Expression 3 ]$$

$$max \{ ceil ( \frac{{\sum }_{k ∈ [ r ]} \vert V [ k ] \vert}{n} ) , 1 \} \qquad ( 3 )$$

Note that Expression 3 corresponds to a number that is obtained by dividing the bit length of the bit sequence V[1]∥V[2]∥ . . . ∥V[r] obtained by concatenating the elements of the vector with one another in which the length of an element consisting of an empty sequence is defined as zero by the input/output bit length n of the encryption function E_K. In other words, Expression 3 corresponds to the number of message blocks obtained by dividing the concatenation data (V[1]∥V[2]∥ . . . ∥V[r]) into blocks each having n bits. Therefore, in the method according to this example embodiment, the processing of the MAC for input data consisting of a plurality of elements can be considered to be efficient. That is, in this example embodiment, it is possible to efficiently generate a tag irrespective of the number of elements and the length of each element.

### First Example Embodiment

An example embodiment will be described hereinafter with reference to the drawings. For the sake of clarifying the explanation, the following descriptions and drawings are omitted and simplified as appropriate. Further, the same elements are assigned the same reference numerals (or symbols) throughout the drawings, and redundant descriptions are omitted as appropriate.

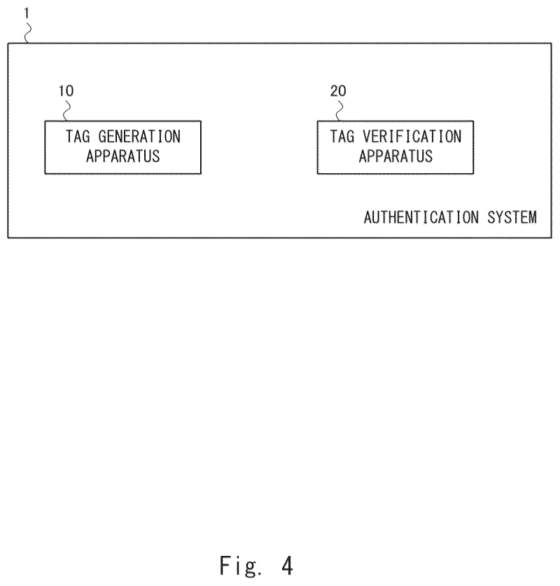

FIG. 4 shows a configuration of an authentication system 1 according to the present disclosure. The authentication system 1 includes a tag generation apparatus 10 and a tag verification apparatus 20. The tag generation apparatus 10 and the tag verification apparatus 20 may be physically-integrated one apparatus, or may be apparatuses physically separated from each other. When the tag generation apparatus 10 and the tag verification apparatus 20 are physically separated from each other, the tag generation apparatus 10 and the tag verification apparatus 20 are connected to each other through a wire or wirelessly so that they can communicate with each other. Further, components of the tag generation apparatus 10 (which will be described later) may be implemented in a plurality of apparatuses separated from each other. Similarly, components of the tag verification apparatus 20 (which will be described later) may be implemented in a plurality of apparatuses separated from each other. Further, in the example of communication shown in FIG. 1, the tag generation apparatus 10 corresponds to the sender, and the tag verification apparatus 20 corresponds to the receiver. In other words, communication is performed between the tag generation apparatus 10 and the tag verification apparatus 20.

### <Tag Generation Apparatus>

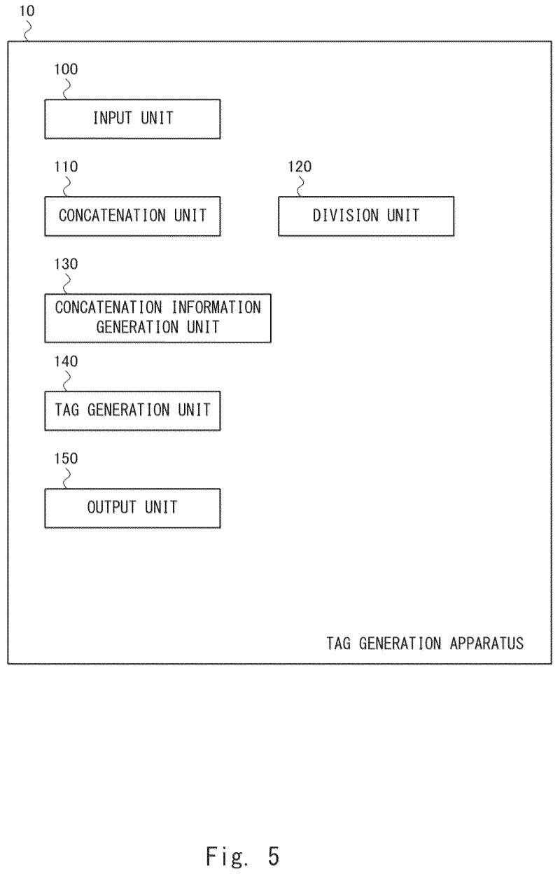

FIG. 5 shows an example of a configuration of the tag generation apparatus 10 according to the present disclosure. The tag generation apparatus 10 includes an input unit 100, a concatenation unit 110, a division unit 120, a concatenation information generation unit 130, a tag generation unit 140, and an output unit 150.

The tag generation apparatus 10 can be implemented, for example, by an information processing apparatus such as a computer. That is, the tag generation apparatus 10 includes a calculation apparatus such as a CPU (Central Processing Unit) and a storage device such as a memory or a disk. The tag generation apparatus 10 implements each of the above-described components, for example, by having the calculation apparatus execute a program(s) stored in the storage device. These features also apply to other example embodiments described later.

The input unit 100 functions as input means. The concatenation unit 110 functions as concatenation means. The division unit 120 functions as division means. The concatenation information generation unit 130 functions as concatenation information generation means. The tag generation unit 140 functions as tag generation means. The output unit 150 functions as output means.

The input unit 100 receives input data V consisting of a plurality of elements. As described above, the input data is, for example, vector data. The input vector V (input data V) is expressed, for example, as V=(V[1], V[2], . . . , V[r]). Note that r is the number of elements of the input vector. The input unit 100 may be implemented, for example, by an input device such as a keyboard. The input unit 100 may receive input data V from, for example, an external apparatus connected thereto through a network. The input unit 100 outputs the input data V to the concatenation unit 110 and the concatenation information generation unit 130.

The concatenation unit 110 generates concatenation data obtained by concatenating the elements of the input data with one another. Specifically, the concatenation unit 110 concatenates the elements (V[k] (k=1, . . . , r)) of the input vector V with one another and thereby generates a message M consisting of a single bit sequence. Note that the “message M” corresponds to the “concatenation data”. Note that the message M is expressed as M=V[1]∥V[2]∥ . . . ∥V[r]. The concatenation unit 110 outputs the concatenation data (message M) to the division unit 120.

The division unit 120 divides the concatenation data into blocks each having a predetermined data length and thereby acquires a plurality of message blocks. Note that as described above, the “predetermined data length” corresponds to the input bit length (n bits) of the block cipher. Specifically, the division unit 120 divides the message M into blocks each having n bits as shown by the below-shown Expression 4.

$$\begin{matrix}[ Expression 4 ] & \\ {parse}_{n} ( M ) \to ( M [ 1 ] , M [ 2 ] , … , M [ m ] ) \vert M [ i ] \vert = n for i < m , \vert M [ m ] \vert \leq n & ( 4 )\end{matrix}$$

Note that “parse_n(M)” is a function for dividing the message M into n-bit blocks. Further, m is the number of message blocks. Therefore, M[m] represents the last message block. In this way, the division unit 120 acquires a plurality of message blocks M[1], M[2], . . . , M[m]. The division unit 120 outputs the plurality of message blocks to the concatenation information generation unit 130 and the tag generation unit 140.

The concatenation information generation unit 130 generates, for each of the plurality of message blocks, concatenation information (i.e., a piece of concatenation information) corresponding to the message block. Specifically, the concatenation information generation unit 130 generates concatenation information (i.e., pieces of concatenation information) D[i] (i=1, . . . , m) as shown by the below-shown Expression 5. Note that the concatenation information D[i] indicates a delimiter(s) (cut-point(s)) of elements in the message block M[i]. Therefore, the concatenation information can also be called Cut-Point Information (CPI).

$$\begin{matrix}[ Expression 5 ] & \\ extract ( L ( V ) ) \to ( D [ 1 ] , D [ 2 ] , … , D [ m ] ) & ( 5 )\end{matrix}$$

Note that extract (L(V)) is a function for generating concatenation information. Note that L (V) indicates information about the length of each element of the vector V. Specifically, extract (L(V)) receives the length of each element V[k] (k=1, . . . , r) of the vector V as an input and outputs concatenation information D[i] corresponding to each message block M[i].

More specifically, the concatenation information generation unit 130 may perform the below-shown processing by using extract (L(V)), and thereby extract information. That is, the concatenation information generation unit 130 adds up the lengths (numbers of bits) of the elements V[k] of the vector V one after another starting from the element V[1]. The concatenation information generation unit 130 increments the index i of the message block M[i] every time the number of added bits becomes n bits. Note that “i-th added n bits” corresponds to a message block M[i]. The concatenation information generation unit 130 extracts a position at which the elements V[k] are changed in the i-th added n bits. In other words, the concatenation information generation unit 130 extracts a position at which elements are connected with each other in the i-th added n bits. Further, the concatenation information generation unit 130 extracts the position(s) of element(s) which is an empty sequence(s) and the number thereof in the i-th added n bits in each of the plurality of message blocks.

For example, assume that: |V[1]|=n1; |V[2]|=0; and |V[3]|=n3. Assume that: n1<n; n3<n; and n1+n3>n. Note that V[2] is an element consisting of an empty sequence. In this case, “first added n bits” correspond to the message block M[1]. Further, the message block M[1] corresponds to a bit sequence obtained by concatenating the whole n1 bits of V[1], the whole 0 bits of V[2], and the first n-n1 bits of V[3]. Therefore, the concatenation information generation unit 130 extracts the position of the n1-th bit from the head (i.e., from the first bit) of the first added n bits as the position at which the elements are changed. Further, the concatenation information generation unit 130 extracts (i.e., determines) that there is one element consisting of an empty sequence at the position of the n1-th bit from the head of the first added n bits. The concatenation information generation unit 130 generates concatenation information D[1] indicating the information extracted as described above.

The concatenation information generation unit 130 generates concatenation information D[i] (i.e., a piece of concatenation information) for each message block M[i] as described above. Specific examples of the concatenation information D[i] will be described later. The concatenation information generation unit 130 outputs the generated concatenation information to the tag generation unit 140.

Note that in this example embodiment, a vector space in which an input vector (input data consisting of a plurality of elements) is expressed can be arbitrarily defined. For example, in the vector space, a maximum value (i.e., maximum number) for the number of elements and a possible bit length for each element can be designated. The possible bit length for each element may be defined, for example, as {8, 16, . . . } in the case of a byte sequence. Alternatively, the possible bit length for each element may be defined, for example, as {32, 64, 96, . . . } in the case of a 32 bit word sequence. Further, in the vector space, the length of an element consisting of an empty sequence may be defined as zero. That is, the possible bit length for each element may include zero.

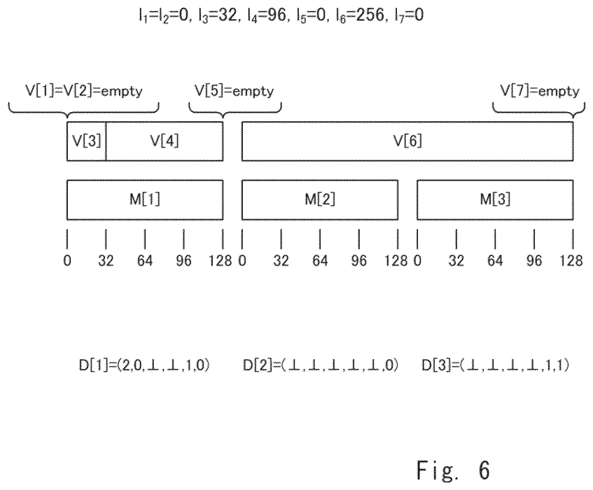

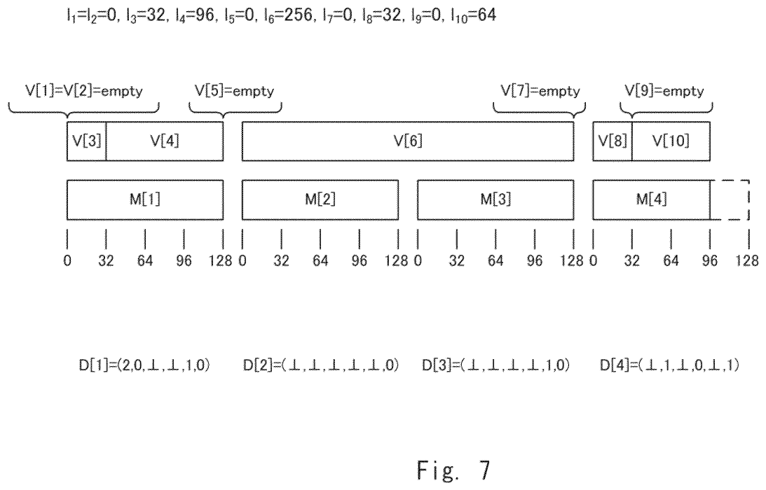

FIGS. 6 and 7 are diagrams for explaining examples of concatenation information according to the present disclosure. FIG. 6 shows a case where the bit length of concatenation data is equal to a multiple of n. Further, FIG. 7 shows a case where the bit length of concatenation data is not equal to a multiple of n. In the examples shown in FIGS. 6 and 7, a vector space in which: n is equal to 128 (n=128); an element length μ is equal to a multiple of 32 including zero; and a maximum value for the number of elements is Rmax is defined. Note that μ may be interpreted as a word size. Further, Rmax may be made roughly equal to 2\hat{ }n−1.

Further, a position at which elements can be concatenated with each other in a message block M[i], i.e., a position at which there is a delimiter (cut-point) between elements in a message block M[i], is referred to as a “connectable position”. When the number of connectable positions in one message block M[i] is represented by ω, the number ω is expressed as ω=n/32=4. A delimiter of elements can be present at 32-nd, 64-th, 96-th, and 128-th bit positions in the message block M[i]. That is, 32-nd, 64-th, 96-th, and 128-th bit positions in the message block M[i] are connectable positions. In the message block M[i], 32-nd bit position is a first connectable position; 64-th bit position is a second connectable position; 96-th bit position is a third connectable position; and 128-th bit position is a fourth connectable position. Note that in the first message block M[1], a delimiter of elements may also present at 0-th bit position in order to express an element consisting of an empty sequence when the first element is an empty sequence. That is, in the message block M[i], 0-th bit position is a 0-th connectable position.

In this case, when the length of an element V[k] in the input vector V=(V[1], V[2], . . . , V[k], . . . , V[r]) is represented by 1_k, it is defined by the below-shown Expression 6.

$$\begin{matrix}[ Expression 6 ] & \\ {ℓ}_{k} = {\vert V [ k ] \vert}_{32} ∈ \{ 0 , 32 , 64 , … \} & ( 6 )\end{matrix}$$

Further, concatenation information D[i] corresponding to a message block M[i] is defined by the below-shown Expression 7.

$$\begin{matrix}[ Expression 7 ] & \\ D [ i ] = ( {α}_{0} , {α}_{1} , … , {α}_{ω} , b ) {α}_{j} ∈ \{ 0 , 1 , 2 , … \} ⋃ \{ ⊥ \} \\ b ∈ \{ 0 , 1 \} & ( 7 )\end{matrix}$$

In the expression, j is an index of a connectable position. Further, α_j indicates the presence/absence of a delimiter of elements at a j-th connectable position and the number of elements each of which consists of an empty sequence present at that position. In other words, α_j indicates whether or not there is actually concatenation (delimiter) of elements at the j-th connectable position and, when there is concatenation, the number of consecutive elements each of which consists of an empty sequence present at that position. The symbol ⊥ indicates a Null value. When there is no concatenation of elements at the j-th concatenable position, α_j is expressed as α_j=⊥. Further, when there is concatenation of elements at the j-th concatenable position, but there is no element consisting of an empty sequence, α_j is zero (α_j=0). Further, when there is concatenation of elements at the j-th concatenable position, and there are x elements (x is an integer equal to or greater than 1) each of which consists of an empty sequence at that position, α_j is equal to x (α_j=x). Further, α_0 indicates the number of elements each of which consists of an empty sequence at the head of the vector V. Therefore, for D[i] (i>1), α_j is expressed as α_0=⊥.

Further, b is an indicator indicating whether or not the message block M[i] corresponding to D[i] is the last message block. When b=0, the message block M[i] corresponding to D[i] is not the last message block, whereas when b=1, the message block M[i] corresponding to D[i] is the last message block. In other words, in the case where the number of message blocks M[i] is m, when i≠m, b is equal to zero (b=0), whereas when i=m, b is equal to one (b=1).

In the example shown in FIG. 6, the input vector V includes seven elements V[1], V[2], . . . , and V[7]. Further, the elements V[1], V[2], V[5] and V[7] are empty sequences. Further, the bit length of the element V[3] is 32 bits; the bit length of the element V[4] is 96 bits; and the bit length of the element V[6] is 256 bits. In this case, since the bit length of the concatenation data M=V[1]∥V[2]∥ . . . ∥V[7] is 384 bits (=128×3), the concatenation data (message M) is divided into three n-bit message blocks M[1], M[2] and M[3]. In this case, the concatenation information generation unit 130 uniquely generates concatenation information (i.e., pieces of concatenation information) D[1], D[2] and D[3] as described hereinafter.

In the message block M[1], two empty sequence elements V[1] and V[2] are present at the 0-th connectable position. Further, in the message block M[1], the elements V[3] and V[4] are concatenated with each other at the first connectable position. Further, one empty sequence element V[5] is present at the fourth connectable position. In other words, in the message block M[1], the elements V[4] and V[5] are concatenated with each other at the fourth connectable position, and the element V[5] is an empty sequence element. Therefore, the concatenation information generation unit 130 generates concatenation information D[1] expressed as D[1]=(2, 0, ⊥, ⊥, ⊥, 0).

In the message block M[2], there is no concatenation of elements at any of the connectable positions. Therefore, the concatenation information generation unit 130 generates concatenation information D[2] expressed as D[2]=(⊥, ⊥, ⊥, ⊥, ⊥, 0).

In the message block M[3], there is no concatenation of elements in the first to third connectable positions. Further, in the message block M[3], one empty sequence element V[7] is present at the fourth connectable position. In other words, in the message block M[3], concatenation of the elements V[6] and V[7] is present at the fourth connectable position, and the element V[7] is an empty sequence element. Further, the message block M[3] is the last message block. Therefore, the concatenation information generation unit 130 generates concatenation information D[3] expressed as D[3]=(⊥, ⊥, ⊥, ⊥, 1, 1).

In the example shown in FIG. 7, the input vector V includes ten elements V[1], V[2], . . . , V[10]. Further, the element V[1], V[2], V[5], V[7] and V[9] are empty sequences. Further, the bit length of the element V[3] is 32 bits; the bit length of the element V[4] is 96 bits; and the bit length of the element V[6] is 256 bits. Further, the bit length of the element V[8] is 32 bits, and the bit length of the element V[10] is 64 bits. In this case, since the bit length of the concatenation data M=V[1]∥V[2]∥ . . . ∥V[10] is 480 bits (=128×3+96), the concatenation data (message M) is divided into four message blocks M[1], M[2], M[3] and M[4]. Further, M[4] is smaller than n (M[4]<n). In this case, the concatenation information generation unit 130 uniquely generates concatenation information (i.e., pieces of concatenation information) D[1], D[2], D[3] and D[4] as described hereinafter.

For the message blocks M[1] and M[2], the concatenation information generation unit 130 generates concatenation information D[1] and D[2] similar to those shown in FIG. 6. Further, the concatenation state of the message block M[3] is substantially the same as that shown in FIG. 6, but the message block M[3] is not the last message block. Therefore, the concatenation information generation unit 130 generates concatenation information D[3] expressed as D[3]=(⊥, ⊥, ⊥, ⊥, 1, 0).

In the message block M[4], one empty sequence element V[9] is present at the first connectable position. In other words, in the message block M[4], concatenation of the elements V[8] and V[9] is present at the first connectable position, and the element V[9] is an empty sequence element. Further, in the message block M[4], no concatenation of elements is present at the second connectable position. Further, in the message block M[4], the end of the last element V[10], which is the last element, is present at the third connectable position. That is, in the message block M[4], a cut-point of the element V[10] is present at the third connectable position. Further, in the message block M[4], since there is no bit sequence at the fourth connectable position, there is no concatenation there. Further, the message block M[4] is the last message block. Therefore, the concatenation information generation unit 130 generates concatenation information D[4] expressed as D[4]=(⊥, 1, ⊥, 0, ⊥, 1).

Note that in the concatenation information D[m] corresponding to the last message block M[m], the last position at which a value other than 1 appears as viewed in the order of α_1 to α_ω corresponds to the end of the bit sequence in the last message block M[m]. Further, in the concatenation information D[3] shown in FIG. 6, a value that is other than 1 appears the last is α_4 (=1). Therefore, it can be determined that the end of the bit sequence in the last message block M[3] is a position corresponding to α_4, and hence the length of the last message block M[3] is 128 bits. Further, in the concatenation information D[4] shown in FIG. 7, the value that is other than 1 appears the last is α_3 (=0). Therefore, it can be determined that the end of the bit sequence in the last message block M[4] is a position corresponding to α_3, and hence the length of the last message block M[4] is 96 bits.

The tag generation unit 140 generates an authentication tag T. Specifically, the tag generation unit 140 generates a tag T by a block cipher by using each of the message blocks M[i] and each of the concatenation information D (i.e., the pieces of concatenation information) corresponding to the respective message blocks M[i]. More specifically, the tag generation unit 140 generate a tag T by generating a plurality of random numbers corresponding to the respective message blocks M[i] by a block cipher by using the concatenation information D[i] (i.e., the pieces of concatenation information D[i]) corresponding to the respective message blocks M[i].

More specifically, the tag generation unit 140 may generate a tag T by encrypting each of the message blocks M[i] by a block cipher by using the concatenation information D[i] (i.e., the piece of concatenation information D[i]) corresponding to the message block M[i]. In this case, the tag generation unit 140 may generate a tag T by encrypting each of the message blocks M[i] by a Tweakable block cipher in which the concatenation information D[i] (i.e., the piece of concatenation information D[i]) corresponding to the message block M[i] is used as a Tweak. As will be described later, the tag generation unit 140 acquires, as the tag T, an encryption result obtained by processing the last message block M[m] by the block cipher. The tag generation unit 140 outputs the generated authentication tag T to the output unit 150. Details of these features will be described later.

Further, the tag generation unit 140 may generate a tag T by successively processing a plurality of message blocks M[i] by the above-described CMAC technology. That is, the tag generation unit 140 may encrypt each of the message blocks M[i] by a Tweakable block cipher in which concatenation information D[i] (i.e., the piece of concatenation information D[i]) corresponding to the message block M[i] is used as a Tweak. Further, the tag generation unit 140 may generate a tag T by performing a process for adding (XOR) an obtained encryption result to the next message block M[i+1]. Details of these features will be described later.

Further, the tag generation unit 140 may generate a tag T by processing a plurality of message blocks M[i] in parallel with each other by the above-described PMAC technology. That is, the tag generation unit 140 may encrypt the message blocks M[i] in parallel with each other by Tweakable block ciphers in which concatenation information D[i] (i.e., the pieces of concatenation information D[i]) corresponding to the respective message blocks M[i] and the indices i of the message blocks M[i] are used as Tweaks. Further, the tag generation unit 140 may generate a tag T by adding up (XOR) obtained encryption results. Details of these features will be described later.

Alternatively, the tag generation unit 140 may generate a tag T by a method similar to the CMAC without using the Tweakable block cipher. That is, the tag generation unit 140 may generate a tag T by encrypting each of the message blocks M[i] by a block cipher and converting an obtained encryption result using concatenation information D[i] (i.e., the piece of concatenation information D[i]) corresponding to the message block M[i]. Details of these features will be described later.

The output unit 150 performs control for outputting the input vector V (input data V) and the tag T. For example, the output unit 150 may perform control for displaying the input vector V and the tag T on an output device such as a display device. Further, the output unit 150 may perform control for outputting the input vector V and the tag T to, for example, an external apparatus connected thereto through a network. For example, the output unit 150 transmits a pair (V, T) to the tag verification apparatus 20.

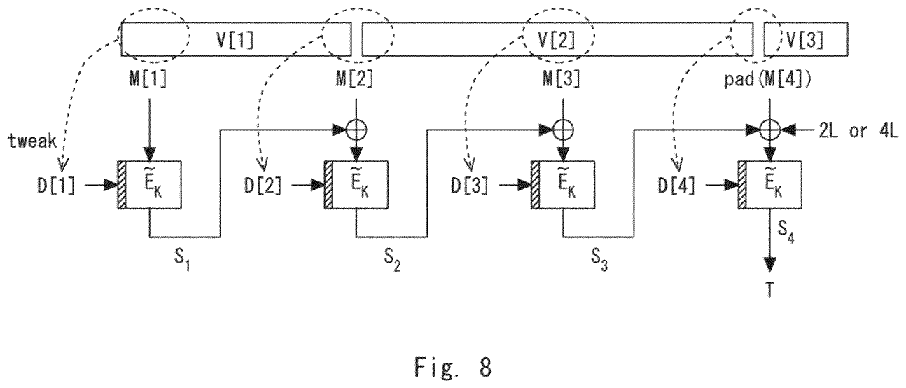

FIGS. 8 to 11 are diagrams for explaining outlines of operations performed by the tag generation unit 140 according to the present disclosure. FIG. 8 shows an example of an outline of an operation that is performed when a tag Tis generated by the above-described CMAC method. FIG. 8 shows an example of a case where a tag T is generated from an input vector V consisting of three elements V[1], V[2] and V[3]. The concatenation unit 110 concatenates the elements V[1], V[2] and V[3] with one another, and thereby generates a message M consisting of a single bit sequence. Note that the message M is expressed as M=V[1]∥V[2]∥V[3]. Further, the division unit 120 divides the message M into four message blocks M[1], M[2], M[3] and M[4]. Note that relations |M[1]|=|M[2]|=|M[3]|=n, and |M[4]|≤n hold.

The concatenation information generation unit 130 generates concatenation information (i.e., pieces of concatenation information) D[1], D[2], D[3] and D[4] corresponding to the message blocks M[1], M[2], M[3] and M[4], respectively, as shown by Expression 5. The concatenation information D[1], D[2], D[3] and D[4] are information related to the concatenation of elements in the message blocks M[1], M[2], M[3] and M[4], respectively. That is, the concatenation information D[1], D[2], D[3] and D[4] can indicate delimiters of elements in the message blocks M[1], M[2], M[3] and M[4], respectively. For example, when the length of each element of the input vector V satisfies the above-shown Expression 6, the concatenation information generation unit 130 may generate concatenation information D[1], D[2], D[3] and D[4] as shown in FIGS. 6 and 7. In this case, the concatenation information D[1], D[2], D[3] and D[4] can be expressed by the above-shown Expression 7.

The tag generation unit 140 generates a tag T by successively processing a plurality of message blocks M[i] by the above-described CMAC method. Specifically, the tag generation unit 140 encrypts the first message block M[1] by a TBC function E_K^{˜} using the concatenation information D[1] as a Tweak, and thereby acquires a random number S_1 as the encryption result. The tag generation unit 140 encrypts a value obtained by the exclusive OR of the random number S_1 and the second message block M[2] by the TBC function E_K^{˜} using the concatenation information D[2] as a Tweak, and thereby acquires a random number S_2 as the encryption result. After that, similarly, the tag generation unit 140 encrypts a value obtained by the exclusive OR of a random number S_i and an (i+1)-th message block M[i+1] by the TBC function E_K^{˜} using concatenation information D[i+1] as a Tweak. In this way, the tag generation unit 140 acquires a random number S_(i+1) as the encryption result. Then, the tag generation unit 140 encrypts a value obtained by the exclusive OR of a random number S_(m−2) and a (m−1)-th message block M[m−1] by the TBC function E_K^{˜} using concatenation information D[m−1] as a Tweak. In this way, the tag generation unit 140 acquires a random number S_(m−1) as the encryption result. In this way, the tag generation unit 140 successively processes the message blocks M[i] (i=1, . . . , m−1).

Then, the tag generation unit 140 performs a padding process on the message block M[m], which is the last message block, and thereby acquires an n-bit sequence pad (M[m]) corresponding to the message block M[m]. Note that when |M[m]|=n, pad (M[m]) is equal to M[m] (pad (M[m])=M[m]). Further, when |M[m]|<n, pad (M[m]) is expressed as pad (M[m])=M[m]∥10 . . . 0. The tag generation unit 140 encrypts a value, obtained by the exclusive OR of the random number S_(m−1), the bit sequence pad (M[m]), and a predetermined mask value, by the TBC function E_K^{˜} using the concatenation information D[m] as a Tweak. In this way, the tag generation unit 140 acquires a random number S_m as the encryption result. The tag generation unit 140 acquires the random number S_m, which is the result of the above-described encryption, as the tag T. Note that the “predetermined mask value” is calculated by using a value L. The “predetermined mask value” may be substantially the same as that described above with reference to FIG. 2.

In the example shown in FIG. 8, the tag generation unit 140 encrypts, as precomputation, an initial value 0\hat{ }n by the TBC function E_K^{˜} using an appropriate Tweak, and thereby acquires the value L as the encryption result. The tag generation unit 140 encrypts the first message block M[1] by the TBC function E_K-using the concatenation information D[1] as a Tweak, and thereby acquires a random number S_1 as the encryption result. The tag generation unit 140 encrypts a value obtained by the exclusive OR of the random number S_1 and the second message block M[2] by the TBC function E_K^{˜} using the concatenation information D[2] as a Tweak, and thereby acquires a random number S_2 as the encryption result. The tag generation unit 140 encrypts a value obtained by the exclusive OR of the random number S_2 and the third message block M[3] by the TBC function E_K^{˜} using the concatenation information D[3] as a Tweak, and thereby acquires a random number S_3 as the encryption result.

Then, the tag generation unit 140 performs a padding process on the message block M[4], which is the last message block, and thereby acquires an n-bit sequence pad (M[4]) corresponding to the message block M[4]. The tag generation unit 140 encrypts a value obtained by the exclusive OR of the random number S_3, the bit sequence pad (M[4]), and a predetermined mask value (2 L or 4 L) by the TBC function E_K^{˜} using the concatenation information D[4] as a Tweak, and thereby acquires a random number S_4 as the encryption result. The tag generation unit 140 acquires this encryption result S_4 as a tag T. Note that by incorporating information for distinguishing (i.e., indicating) whether or not the number of bits in the last message block M[m] is n bits into the concatenation information D[m] corresponding to the last message block M[m], it becomes unnecessary to generate the predetermined mask value.

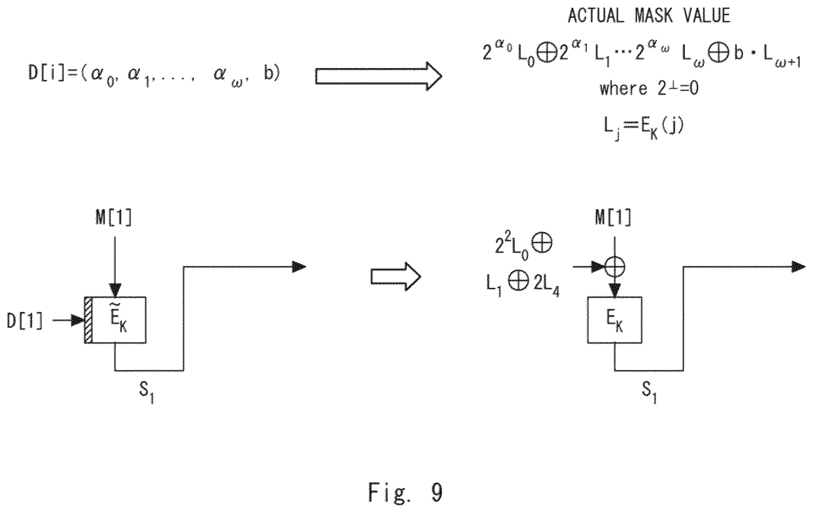

FIG. 9 is a diagram for explaining an example of a method for implementing a Tweakable block cipher shown in FIG. 8 by a block cipher. FIG. 9 shows an example of a method for implementing a Tweakable block cipher by a block cipher (encryption function E_K) by a technology substantially the same as an XEX mode disclosed in Non-patent Literature 2. Note that the method for implementing a Tweakable block cipher by a block cipher is not limited to the method shown in FIG. 9. Further, the Tweakable block cipher shown in FIG. 8 may be implemented by a method other than the method using a block cipher. For example, the Tweakable block cipher may be implemented by a technology disclosed in Non-patent Literature 4.

When the tag generation unit 140 performs a process for encrypting a message block M[i] by a Tweakable block cipher by using concatenation information D[i] as a Tweak, it may perform the following process. That is, the tag generation unit 140 inputs a value obtained by the exclusive OR of the message block M[1] and a mask value Δ corresponding to the concatenation information D[1] into the encryption function E_K. In this way, the tag generation unit 140 acquires a random number S_1 as the encryption result. Note that for i≥2, the tag generation unit 140 inputs a value obtained by the exclusive OR of a message block M[i], a mask value Δ corresponding to concatenation information D[i], and a random number S_(i−1) into the encryption function E_K. In this way, the tag generation unit 140 acquires a random number S_i as the encryption result.

Note that the tag generation unit 140 may generate the mask value Δ corresponding to the concatenation information D[i] as follows. The below-shown Expression 8 shows an example of the mask value Δ corresponding to the concatenation information D[i]. The tag generation unit 140 calculates a mask value Δ expressed by the below-shown Expression 8 for each of D[i] (i.e., each of the pieces of concatenation information D[i]) expressed by the above-shown Expression 7. Note that in Expression 8, a circled “+” represents an exclusive OR (XOR).

$$\begin{matrix}[ Expression 8 ] & \\ {2}^{{α}_{0}} {L}_{0} ⊕ {2}^{{α}_{1}} {L}_{1} ⊕ … ⊕ {2}^{{α}_{ω}} {L}_{ω} ⊕ b \cdot {L}_{ω + 1} where {2}^{⊥} = 0 & ( 8 )\end{matrix}$$

For example, when D[1]=(2, 0, ⊥, ⊥, 1, 0), the mask value Δ corresponding to D[1] is expressed by the below-shown Expression 9.

$$\begin{matrix}[ Expression 9 ] & \\ {2}^{2} {L}_{0} ⊕ {L}_{1} ⊕ 2 {L}_{4} & ( 9 )\end{matrix}$$

Further, for example, when D[2]=(⊥, ⊥, ⊥, ⊥, ⊥, 0), the mask value Δ corresponding to D[2] is a bit sequence consisting of n bits in which all the bits are zero (0\hat{ }n). Further, for example, when D[3]=(⊥, ⊥, ⊥, ⊥, 1, 1), the mask value Δ corresponding to D[3] is expressed by the below-shown Expression 10.

$$\begin{matrix}[ Expression 10 ] & \\ 2 {L}_{4} ⊕ {L}_{5} & ( 10 )\end{matrix}$$

Further, for example, when D[4]=(⊥, 1, ⊥, 0, ⊥, 1), the mask value Δ corresponding to D[4] is expressed by the below-shown Expression 11.

$$\begin{matrix}[ Expression 11 ] & \\ 2 {L}_{1} ⊕ {L}_{3} ⊕ {L}_{5} & ( 11 )\end{matrix}$$

Note that the tag generation unit 140 may calculate L_j (j=0, 1, . . . , @, @+1) by precomputation. L_j is expressed by, for example, the below-shown Expression 12.

$$\begin{matrix}[ Expression 12 ] & \\ {L}_{j} = {E}_{K} ( j ) & ( 12 )\end{matrix}$$

Note that L_j may be calculated by encrypting an arbitrary constant unique to each j by the encryption function E_K. For example, L_j may be acquired by encrypting the index j itself, i.e., the number “j”, by the encryption function E_K as shown by Expression 9. Alternatively, for example, L_j may be acquired by encrypting “j+N” (N is an arbitrary constant) by the encryption function E_K. Alternatively, for example, L_j may be acquired by encrypting “j*N” by the encryption function E_K.

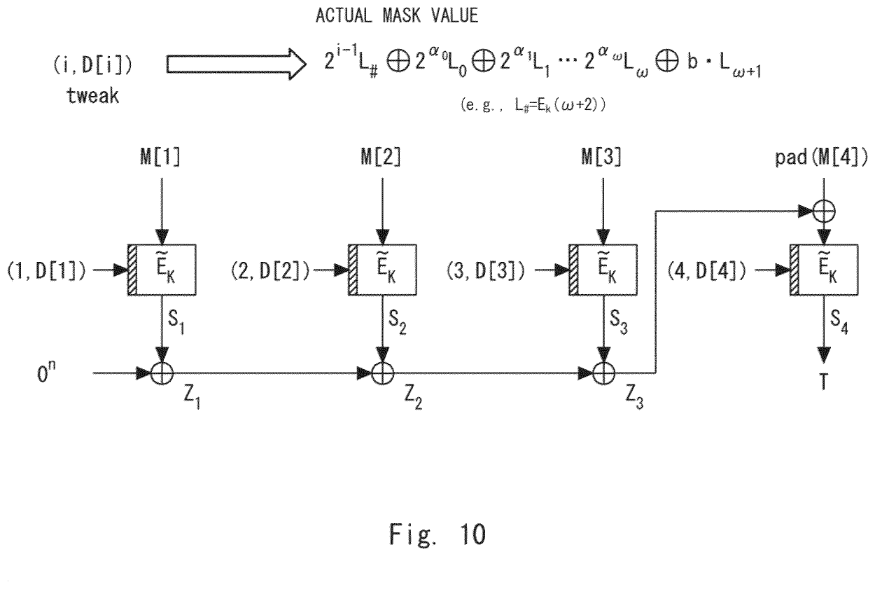

Further, the tag generation unit 140 calculates 2\hat{ }(α_j)L_j for each α_j of D[i] as shown by Expression 8. Note that “2” is a generator on the finite field GF(2\hat{ }n). Further, “2 L” is a generator multiplication on the finite field GF(2\hat{ }n). Therefore, “2\hat{ }(α_j)L_j” is a generator multiplication on the finite field GF(2\hat{ }n). That is, “2\hat{ }(α_j)L_j” corresponds to repeating a process “2L_j” (twofold multiplication) α_j times. For example, when α_j=1, “2\hat{ }(α_j)L_j” corresponds to performing one-bit left shift for L_j, which is an n-bit bit sequence. Specifically, when the most significant bit (i.e., the highest bit) of L_j is 0, “2\hat{ }(α_j)L_j” corresponds to performing one-bit left shift for L_j. Further, when the most significant bit of L_j is 1, “2\hat{ }(α_j)L_j” corresponds to a value obtained by the exclusive OR of a value obtained by performing one-bit left shift for L_j and a predetermined constant cst. Note that the constant cst is a certain n-bit value determined based on the definition of GF(2\hat{ }n). Such a generator multiplication on the finite field GF(2\hat{ }n) can be implemented by a very simple process compared with a single process of a block cipher. Further, the calculation of the mask value Δ shown by Expression 8 can be successively performed starting from the first element of the input vector. Therefore, the calculation of the mask value Δ corresponding to the concatenation information D[i] can be efficiently performed without excessively using calculation resources. These features also hold true for an example shown in FIG. 10 (which will be described later).

Further, since “2\hat{ }(α_j)L_j” is a generator multiplication on the finite field GF(2\hat{ }n) as described above, “2\hat{ }(α_j)L_j” has a value unique to each of different α_j when α_j is equal to or smaller than 2\hat{ }n−1. Therefore, in view of the security, α_j should be equal to or smaller than 2\hat{ }n−1. Note that α_j has the largest possible value when all the elements are empty sequences. That is, the maximum value of α_j is Rmax. Therefore, in the first example embodiment, Rmax can be set to 2\hat{ }n−1. As described above, in the first example embodiment, the number of elements can be set to an extremely large number, i.e., can be set to 2\hat{ }n−1. These features also hold true for an example shown in FIG. 10 (which will be described later).

FIG. 10 shows an example of an outline of an operation that is performed when a tag T is generated by the above-described PMAC method. In the example shown in FIG. 10, similarly to the example shown in FIG. 8, the division unit 120 divides the message M into four message blocks M[1], M[2], M[3] and M[4]. Further, similarly to the example shown in FIG. 8, the concatenation information generation unit 130 generates concatenation information (i.e., pieces of concatenation information) D[1], D[2], D[3] and D[4] corresponding to the message blocks M[1], M[2], M[3] and M[4], respectively, as shown by Expression 5. Note that as described above, when the length of each element of the input vector V satisfies the above-shown Expression 6, the concatenation information generation unit 130 may generate concatenation information D[1], D[2], D[3] and D[4] as shown in FIGS. 6 and 7. In this case, the concatenation information D[1], D[2], D[3] and D[4] can be expressed by the above-shown Expression 7.

The tag generation unit 140 generates a tag T by processing a plurality of message blocks M[i] in parallel with each other by the above-described PMAC technology. Specifically, for i=1, . . . , m−1, the tag generation unit 140 encrypts an i-th message block M[i] by a TBC function E_K^{˜} in which a pair (i, D[i]) consisting of concatenation information D[i] and an index “i” is used as a Tweak. In this way, the tag generation unit 140 acquires a random number S_i as the encryption result. Then, the tag generation unit 140 encrypts a message block M[m−1] by the TBC function E_K^{˜} using a pair (m−1, D[m−1]) consisting of concatenation information D[m−1] and an index “m−1” as a Tweak, and thereby acquires a random number S_(m−1) as the encryption result. In this way, the tag generation unit 140 performs parallel processing for the message blocks M[i] (i=1, . . . , m−1).

Further, the tag generation unit 140 acquires a random number Z_(m−1) by the exclusive OR of an initial value 0\hat{ }n and random numbers S_1, . . . , S_(m−1). Further, the tag generation unit 140 performs a padding process on the message block M[m], which is the last message block, and thereby acquires an n-bit bit sequence pad (M[m]) corresponding to the message block M[m]. Further, the tag generation unit 140 encrypts a value obtained by the exclusive OR of the random number Z_(m−1) and the bit sequence pad (M[m]) by the TBC function E_K^{˜} using a pair (m, D[m]) consisting of concatenation information D[m] and an index “m” as a Tweak. In this way, the tag generation unit 140 acquires a random number S_m as the encryption result. The tag generation unit 140 acquires the random number S_m, which is the result of the above-described encryption, as the tag T.

In the example shown in FIG. 10, the tag generation unit 140 encrypts the first message block M[1] by the TBC function E_K^{˜} using a pair (1, D[1]) consisting of concatenation information D[1] and an index “1” as a Tweak, and thereby acquires a random number S_1 as the encryption result. The tag generation unit 140 encrypts the second message block M[2] by the TBC function E_K^{˜} using a pair (2, D[2]) consisting of concatenation information D[2] and an index “2” as a Tweak, and thereby acquires a random number S_2 as the encryption result. The tag generation unit 140 encrypts the third message block M[3] by the TBC function E_K^{˜} using a pair (3, D[3]) consisting of concatenation information D[3] and an index “3” as a Tweak, and thereby acquires a random number S_3 as the encryption result.

Further, the tag generation unit 140 acquires a random number Z_1 by the exclusive OR of the initial value 0\hat{ }n and the random number S_1. Further, the tag generation unit 140 acquires a random number Z_2 by the exclusive OR of the random number Z_1 and the random number S_2. Further, the tag generation unit 140 acquires a random number Z_3 by the exclusive OR of the random number Z_2 and the random number S_3.

Further, the tag generation unit 140 performs a padding process on the message block M[4], which is the last message block, and thereby acquires an n-bit sequence pad (M[4]) corresponding to the message block M[4]. The tag generation unit 140 encrypts a value obtained by the exclusive OR of the random number Z_3 and the bit sequence pad (M[4]) by the TBC function E_K^{˜} using a pair (4, D[4]) consisting of concatenation information D[4] and an index “4” as a Tweak. In this way, the tag generation unit 140 acquires a random number S_4 as the encryption result. The tag generation unit 140 acquires this encryption result S_4 as a tag T.

Note that the Tweakable block cipher shown in FIG. 10 may be implemented by a method using a block cipher as in the technology disclosed in Non-patent Literature 2. Alternatively, the Tweakable block cipher shown in FIG. 10 may be implemented by a technology other than those using a block cipher, such as a technology disclosed in Non-patent Literature 4. When the Tweakable block cipher shown in FIG. 10 is implemented by a block cipher, the Tweakable block cipher may be implemented by a block cipher in substantially the same manner as the XEX mode disclosed in Non-patent Literature 2. In this case, similarly to the example shown in FIG. 9, the tag generation unit 140 inputs a value obtained by the exclusive OR of a message block M[i] and a mask value Δ corresponding to a pair (i, D[i]) consisting of concatenation information D[i] and an index i into the encryption function E_K. In this way, the tag generation unit 140 acquires a random number S_i as the encryption result.

Note that the tag generation unit 140 may generate a mask value Δ corresponding to the pair (i, D[i]) used as a Tweak as shown by the below-shown Expression 13. The below-shown Expression 13 shows an example of a mask value Δ corresponding to the pair (i, D[i]). The tag generation unit 140 calculates a mask value Δ expressed by the below-shown Expression 13 for each of D[i] (i.e., each of pieces of concatenation information D[i]) expressed by the above-shown Expression 7.

$$\begin{matrix}[ Expression 13 ] & \\ {2}^{i - 1} {L}_{\#} ⊕ {2}^{{α}_{0}} {L}_{0} ⊕ {2}^{{α}_{1}} {L}_{1} ⊕ … ⊕ {2}^{{α}_{ω}} {L}_{ω} ⊕ b \cdot {L}_{ω + 1} where {2}^{⊥} = 0 & ( 13 )\end{matrix}$$

Note that the tag generation unit 140 may calculate L_# by precomputation as shown, for example, by the below-shown Expression 14.

$$\begin{matrix}[ Expression 14 ] & \\ {L}_{\#} = {E}_{K} ( ω + 2 ) & ( 14 )\end{matrix}$$

For example, when D[1]=(2, 0, ⊥, ⊥, 1, 0), a mask value Δ corresponding to the pair (1, D[1]) is expressed by the below-shown Expression 15.

$$\begin{matrix}[ Expression 15 ] & \\ {L}_{\#} ⊕ {2}^{2} {L}_{0} ⊕ {L}_{1} ⊕ 2 {L}_{4} & ( 15 )\end{matrix}$$

Further, for example, when D[2]=(⊥, ⊥, ⊥, ⊥, ⊥, 0), a mask value Δ corresponding to the pair (2, D[2]) is 2 L_#. Further, for example, when D[3]=(⊥, ⊥, ⊥, ⊥, 1, 1), a mask value Δ corresponding to D[3] is expressed by the below-shown Expression 16.

$$\begin{matrix}[ Expression 16 ] & \\ {2}^{2} {L}_{\#} ⊕ 2 {L}_{4} ⊕ {L}_{5} & ( 16 )\end{matrix}$$

Further, for example, when D[4]=(1, 1, 1, 0, 1, 1), a mask value Δ corresponding to D[4] is expressed by the below-shown Expression 17.

$$\begin{matrix}[ Expression 17 ] & \\ {2}^{3} {L}_{\#} ⊕ 2 {L}_{1} ⊕ {L}_{3} ⊕ {L}_{5} & ( 17 )\end{matrix}$$

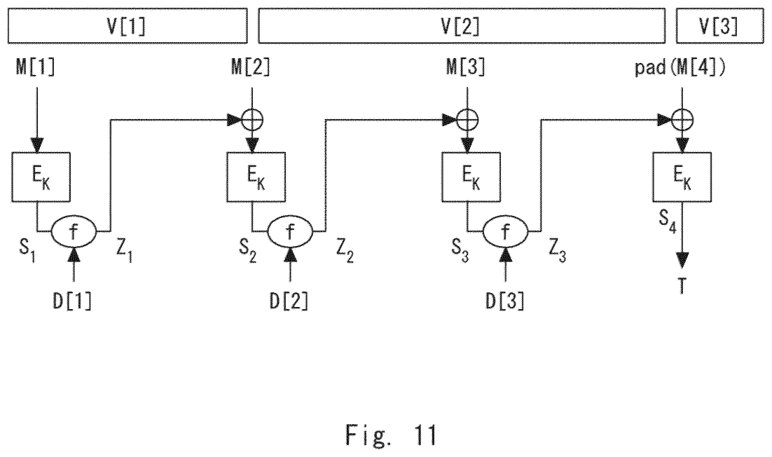

FIG. 11 shows an example of an outline of an operation that is performed when a tag T is generated without using the Tweakable block cipher by a method similar to the above-described CMAC. In FIG. 11, a function f substantially the same as the function disclosed in Non-patent Literature 3 may be used. The function f linearly transforms an encryption result obtained by encrypting a message block M[i] by the encryption function E_K by using concatenation information D[i] as a parameter. The function f will be described later.

In the example shown in FIG. 11, similarly to the example shown in FIG. 8, the concatenation unit 110 concatenates the elements V[1], V[2] and V[3] with one another, and thereby generates a message M consisting of a single bit sequence. Further, the division unit 120 divides the message M into four message blocks M[1], M[2], M[3] and M[4]. Further, the concatenation information generation unit 130 generates concatenation information D[1], . . . , and D[m−2] corresponding to the message blocks M[1], . . . , and M[m−2], respectively, as shown in Expression 5. In the example shown in FIG. 11, the concatenation information generation unit 130 generates concatenation information D[1] and D[2] corresponding to the message blocks M[1] and M[2], respectively, as shown in Expression 5. Note that as described above, when the length of each element of the input vector V satisfies the above-shown Expression 6, the concatenation information generation unit 130 may generate concatenation information D[1] and D[2] as shown in FIGS. 6 and 7. In this case, the concatenation information D[1] and D[2] may be expressed by the above-shown Expression 7.

Further, the concatenation information generation unit 130 generates concatenation information D[m−1] corresponding to the message block M[m−1] and the last message block M[m]. That is, the concatenation information D[m−1] can indicate delimiters of elements in the message blocks M[m−1] and M[m]. In the example shown in FIG. 11, the concatenation information generation unit 130 generates concatenation information D[3] corresponding to the message blocks M[3] and M[4]. That is, the concatenation information D[3] can indicate delimiters of elements in the message blocks M[3] and M[4]. When the length of each element of the input vector V satisfies the above-shown Expression 6, the concatenation information D[3] can include α_j corresponding to two blocks for the message blocks M[3] and M[4].

The tag generation unit 140 encrypts the first message block M[1] by using the encryption function E_K, and thereby acquires a random number S_1 as the encryption result. The tag generation unit 140 generates a random number Z_1 by using the function f which receives the random number S_1 as an input and uses the concatenation information D[1] as a parameter. Further, the tag generation unit 140 encrypts a value obtained by the exclusive OR of the random number Z_1 and the second message block M[2] by using the encryption function E_K, and thereby acquires a random number S_2 as the encryption result. The tag generation unit 140 generates a random number Z_2 by using the function f which receives the random number S_2 as an input and uses the concatenation information D[2] as a parameter.

After that, similarly, the tag generation unit 140 encrypts a value obtained by the exclusive OR of a random number Z_(i−1) and a next message block M[i] by using the encryption function E_K, and thereby acquires a random number S_i as the encryption result. The tag generation unit 140 generates a random number Z_i by using the function f which receives the random number S_i as an input and uses the concatenation information D[i] as a parameter. Then, the tag generation unit 140 encrypts a value obtained by the exclusive OR of a message block M[m−1] and a random number S_(m−2) by using the encryption function E_K, and thereby acquires a random number S_(m−1) as the encryption result. The tag generation unit 140 generates a random number Z_(m−1) by using the function f which receives the random number S_(m−1) as an input and uses the concatenation information D[m−1] as a parameter. In this way, the tag generation unit 140 successively processes the message blocks M[i] (i=1, . . . , m−1).

Then, the tag generation unit 140 performs a padding process on the message block M[m], which is the last message block, and thereby acquires an n-bit sequence pad (M[m]) corresponding to the message block M[m]. The tag generation unit 140 encrypts a value obtained by the exclusive OR of a random number Z_(m−1) and a bit sequence pad (M[m]) by using the encryption function E_K, and thereby acquires a random number S_m as the encryption result. The tag generation unit 140 acquires a random number S_m, which is the result of the above-described encryption, as a tag T.

In the example shown in FIG. 11, the tag generation unit 140 encrypts the first message block M[1] by using the encryption function E_K, and thereby acquires a random number S_1 as the encryption result. The tag generation unit 140 generates a random number Z_1 by using the function f which receives the random number S_1 as an input and uses the concatenation information D[1] is used as a parameter. Further, the tag generation unit 140 encrypts a value obtained by the exclusive OR of the random number Z_1 and the second message block M[2] by using the encryption function E_K, and thereby acquires a random number S_2 as the encryption result. The tag generation unit 140 generates a random number Z_2 by using the function f which receives the random number S_2 as an input and uses the concatenation information D[2] as a parameter. Then, the tag generation unit 140 encrypts a value obtained by the exclusive OR of the message block M[3] and the random number Z_2 by using the encryption function E_K, and thereby acquires a random number S_3 as the encryption result. The tag generation unit 140 generates a random number Z_3 by using the function f which receives the random number S_3 as an input and uses the concatenation information D[3] as a parameter.

Then, the tag generation unit 140 performs a padding process on the message block M[4], which is the last message block, and thereby acquires an n-bit sequence pad (M[4]) corresponding to the message block M[4]. The tag generation unit 140 encrypts a value obtained by the exclusive OR of the random number Z_3 and the bit sequence pad (M[4]) by using the encryption function E_K, and thereby acquires a random number S_4 as the encryption result. The tag generation unit 140 acquires a random number S_4, which is the result of the above-described encryption, as a tag T.

Note that the function f(D, S) may be a function of performing cyclic substitution (cyclic shift) for a bit sequence S the number of times equivalent to the number of bits corresponding to D. Note that the “number of bits corresponding to D[i]” is obtained by associating a predetermined integer with each pattern of concatenation information D[i]. That is, concatenation information D[i] (i.e., pieces of concatenation information D[i]) having patterns different from each other are associated with integers different from each other. For example, the concatenation information pattern “(⊥, ⊥, ⊥, ⊥, ⊥, 0)” shown in FIG. 7 may be mapped to an integer “0”. Further, for example, the concatenation information pattern “(⊥, ⊥, ⊥, ⊥, 1, 0)” shown in FIG. 7 may be mapped to an integer “1”. Further, for example, the concatenation information pattern “(2, 0, ⊥, ⊥, 1, 0)” shown in FIG. 7 may be mapped to an integer “2”.

Note that since the number of bits of the bit sequence S is n bits, when a cyclic shift of n bits is performed to the bit sequence S, it returns to the original bit sequence S. Therefore, the number of bits by which a cyclic shift can be performed for the bit sequence S is smaller than n. Therefore, the number of concatenation information patterns needs to be n or smaller. That is, each concatenation information pattern needs to be mapped to one of integers 0 to n−1. In other words, the vector space (the length of each element and the number of elements) of the input vector V needs to be not so complicated, i.e., to be simple enough so that each concatenation information pattern can be mapped to one of integers 0 to n−1. For example, when the number of elements each of which consists of an empty sequence is enormous, the number of concatenation information patterns may exceed n, thus raising a possibility that the method shown in FIG. 11 cannot be adopted. In contrast, when the vector space of the input vector V has, for example, no element consisting of an empty sequence; the length of each element is equal to a multiple of 32 bits; and n is equal to 128 (n=128), the number of concatenation information patterns never exceeds n. Therefore, the method shown in FIG. 11 can be adopted.

As described above, in the method shown in FIG. 11, there is a constraint on the vector space, i.e., on the concatenation information patterns. Meanwhile, in the method shown in FIG. 11, there is no need to perform the precomputation (calculation of mask values and calculation of L required for the calculation of the mask values), which needs to be performed in the method shown in FIGS. 8 to 10. Therefore, the consumption of the memory for storing values calculated by the precomputation in the method shown in FIG. 11 can be reduced compared with that in the method shown in FIGS. 8 to 10. In other words, when the configuration of the vector space of the input vector V is not complicated and hence the number of concatenation information patterns is small, the consumption of the memory can be reduced by generating a tag by using the method shown in FIG. 11.

Note that the function f is expressed, for example, by using the below-shown Expression 18. Note that the Expression 18 corresponds to the technology disclosed in Non-patent Literature 3.

$$\begin{matrix}[ Expression 18 ] & \\ f ( D [ i ] , S ) = m s {b}_{p} ( {rot}_{D} [ i ] ( S ) ) \vert \vert {0}^{\{ n - p \}} & ( 18 )\end{matrix}$$

Note that conditions that p is a prime number smaller than n and 2 is “primitive root modulo p” are satisfied. That is, p is a prime number smaller than n such that 2 is a primitive root in modulo of p. Further, msb_p (x) indicates left p bits of the bit sequence x, i.e., the higher p bits of the bit sequence x. Further, rot_a (x) indicates that the bit sequence x is cyclically shifted to the left by a bits. Further, rot_D[i] (S) indicates that the bit sequence S is cyclically shifted to the left by an integer corresponding to D[i]. Note that the “integer corresponding to D[i]” is obtained by associating a predetermined integer with each pattern of concatenation information D[i] as described above.

Further, in the function f shown by Expression 18, p is set to a prime number smaller than n (e.g., the largest prime number smaller than n), and the higher p bits are cyclically shifted. Further, each of lower (n-p) bits is set to “0”. In this case, each pattern of concatenation information D[i] needs to be mapped to one of integers 0 to p−1. In this way, f (*, S) becomes AXU (Almost XOR universal). That is, f(X, S)+f(X′, S) becomes a substantially uniform random number for any X that is not equal to X′ (X≠X′). Note that the symbol “+” indicates exclusive OR. Further, X corresponds to an integer associated with a respective one of patterns of concatenation information. When the function f satisfies such conditions, the vector-input MAC shown in FIG. 11 is secured by the technology disclosed in Non-patent Literature 3.

### <Tag Verification Apparatus>

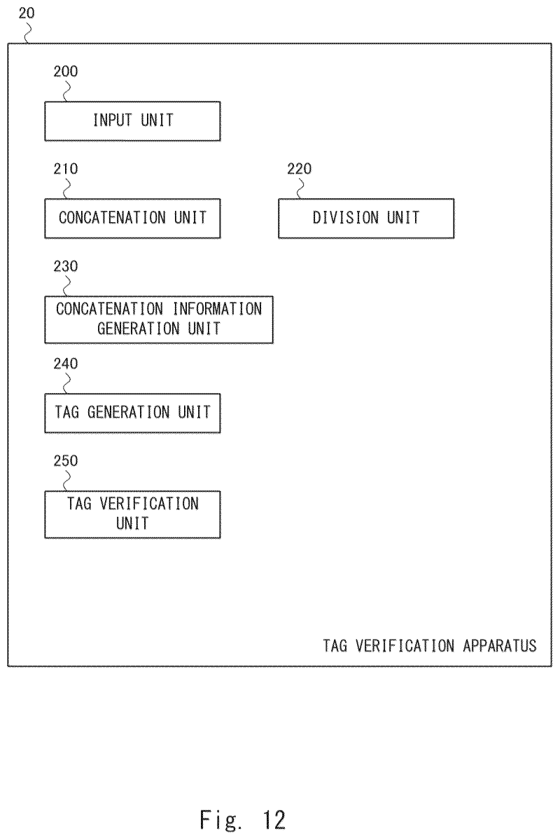

FIG. 12 shows an example of a configuration of a tag verification apparatus 20 according to the present disclosure. The tag verification apparatus 20 includes an input unit 200, a concatenation unit 210, a division unit 220, a concatenation information generation unit 230, a tag generation unit 240, and a tag verification unit 250.

The tag verification apparatus 20 can be implemented, for example, by an information processing apparatus such as a computer. That is, the tag verification apparatus 20 includes a calculation apparatus such as a CPU and a storage device such as a memory or a disk. The tag verification apparatus 20 implements each of the above-described components, for example, by having a calculation apparatus execute a program(s) stored in the storage device. These features also apply to other example embodiments described later.

The input unit 200 functions as input means. The concatenation unit 210 functions as concatenation means. The division unit 220 functions as division means. The concatenation information generation unit 230 functions as concatenation information generation means. The tag generation unit 240 functions as tag generation means. The tag verification unit 250 functions as tag verification means.

The input unit 200 receives input data V (input vector V) and an authentication tag T transmitted from the tag generation apparatus 10. The input unit 200 may be implemented, for example, by an input device such as a keyboard. The input unit 200 may receive input data V and an authentication tag T from, for example, an external apparatus connected thereto through a network. The input unit 200 outputs the input data V to the concatenation unit 210 and the concatenation information generation unit 230. The input unit 200 outputs the authentication tag T to the tag verification unit 250.

The concatenation unit 210 performs substantially the same processing as that performed by the above-described concatenation unit 110. That is, the concatenation unit 210 generates concatenation data obtained by concatenating the elements of the input data (input vector V) with one another. Specifically, the concatenation unit 210 concatenates the elements (V[k] (k=1, . . . , r)) of the input vector V with one another and thereby generates a message M (concatenation data) consisting of a single bit sequence. The concatenation unit 210 outputs the concatenation data (message M) to the division unit 220.

The division unit 220 performs substantially the same processing as that performed by the above-described division unit 120. That is, the division unit 220 divides the concatenation data into blocks each having a predetermined data length (n bits) and thereby acquires a plurality of message blocks. Specifically, the division unit 220 divides the message M into blocks each having n bits as shown by the above-shown Expression 4. In this way, the division unit 220 acquires a plurality of message blocks M[1], M[2], . . . , M[m]. The division unit 220 outputs the plurality of message blocks to the concatenation information generation unit 230 and the tag generation unit 240.

The concatenation information generation unit 230 performs substantially the same processing as that performed by the above-described concatenation information generation unit 130. That is, the concatenation information generation unit 230 generates, for each of the plurality of message blocks, concatenation information (CPI) (i.e., a piece of concatenation information (CPI)) corresponding to the message block. Specifically, the concatenation information generation unit 230 generates concatenation information (i.e., pieces of concatenation information) D[i] (i=1, . . . , m) corresponding to the respective message blocks M[i] as shown by the above-shown Expression 5. Similarly to the concatenation information generation unit 130, the concatenation information generation unit 230 may generate concatenation information as shown in FIGS. 6 and 7. The concatenation information generation unit 230 outputs the generated concatenation information to the tag generation unit 240.

The tag generation unit 240 performs substantially the same processing as that performed by the above-described tag generation unit 140 and thereby generates a verification tag T*. Specifically, the tag generation unit 240 generates a tag T* by a block cipher by using each of the message blocks M[i] and each of the concatenation information D (i.e., the pieces of concatenation information) corresponding to the respective message blocks M[i]. More specifically, the tag generation unit 240 generates a tag T* by generating a plurality of random numbers corresponding to the respective message blocks M[i] by a block cipher by using the concatenation information D[i] (i.e., the pieces of concatenation information D[i]) corresponding to the respective message blocks M[i].

More specifically, the tag generation unit 240 may generate a tag T* by encrypting each of the message blocks M[i] by a block cipher by using the concatenation information D[i] (i.e., the piece of concatenation information D[i]) corresponding to the message block M[i]. In this case, the tag generation unit 240 may generate a tag T* by encrypting each of the message blocks M[i] by a Tweakable block cipher in which the concatenation information D[i] (i.e., the piece of concatenation information D[i]) corresponding to the message block M[i] is used as a Tweak. The tag generation unit 240 may generate a verification tag T* by the method shown in FIGS. 8 to 11. The tag generation unit 240 outputs the generated verification tag T* to the tag verification unit 250.

The tag verification unit 250 compares the verification tag T* generated by the tag generation unit 240 with the authentication tag T generated by the tag generation apparatus 10, and thereby verifies whether or not tampering has occurred. Then, the tag verification unit 250 performs control for outputting information based on the result of the verification. That is, the tag verification unit 250 compares the verification tag T* with the input authentication tag T, and thereby verifies whether or not tampering has occurred. Then, the tag verification unit 250 performs control for outputting the result of the verification.

Specifically, the tag verification unit 250 compares the authentication tag T with the verification tag T*. Then, the tag verification unit 250 determines that the authentication has succeeded when the verification tag T* matches the authentication tag T. Further, when the authentication has succeeded, the tag verification unit 250 performs control for outputting the received input vector V (message M). On the other hand, when the verification tag T* does not match the authentication tag T, the tag verification unit 250 determines that authentication has failed. When the authentication has failed, the tag verification unit 250 performs control for outputting an error message indicating that the authentication has failed.

### <Tag Generation Method and Tag Verification Method>

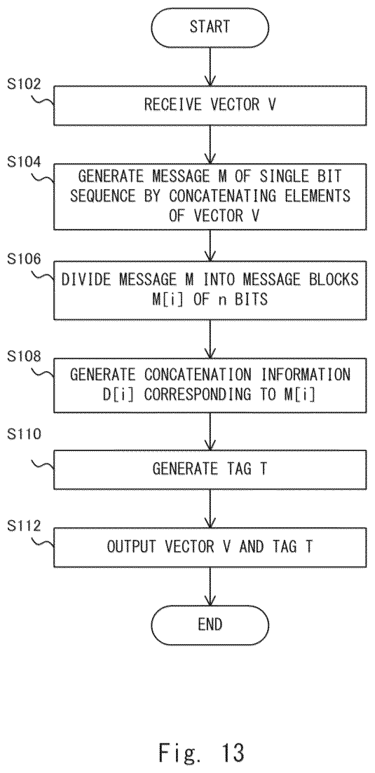

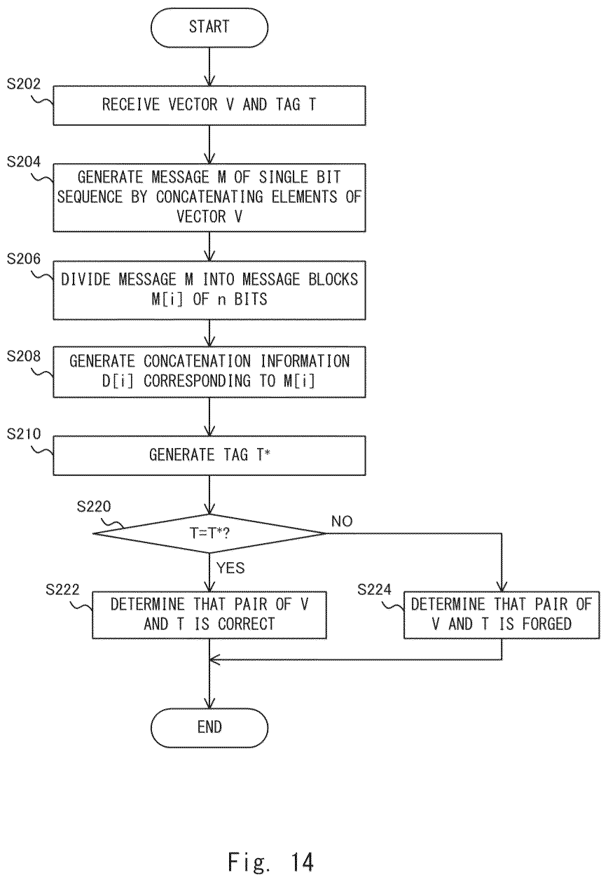

Next, operations performed by the authentication system 1 according to the present disclosure will be described with reference to FIGS. 13 and 14. FIG. 13 is a flowchart showing a tag generation method performed by the tag generation apparatus 10 according to the present disclosure.

As described above, the input unit 100 receives a vector V (Step S102). As described above, the concatenation unit 110 concatenates the elements of the vector V with one another and thereby generates a message M (concatenation data) consisting of a single bit sequence (Step S104). As described above, the division unit 120 divides the message M into n-bit message blocks M[i] (i=1, . . . , m) (Step S106).

As described above, the concatenation information generation unit 130 generates concatenation information D[i] corresponding to the message block M[i] (Step S108). As described above, the tag generation unit 140 generates an authentication tag T by using each of the message blocks M[i] and each of the concatenation information D (i.e., the pieces of concatenation information) corresponding to the respective message blocks M[i] (Step S110). As described above, the output unit 150 outputs the vector V and the tag T (Step S112).

FIG. 14 is a flowchart showing a tag verification method performed by the tag verification apparatus 20 according to the present disclosure. As described above, the input unit 200 receives a vector V and an authentication tag T (Step S202). As described above, the concatenation unit 210 concatenates the elements of the vector V with one another and thereby generates a message M (concatenation data) consisting of a single bit sequence (Step S204). As described above, the division unit 220 divides the message M into n-bit message blocks M[i] (i=1, . . . , m) (Step S206).

As described above, the concatenation information generation unit 230 generates concatenation information D[i] corresponding to the message block M[i] (Step S208). As described above, the tag generation unit 240 generates a verification tag T* by using each of the message blocks M[i] and each of the concatenation information D (i.e., the pieces of concatenation information) corresponding to the respective message blocks M[i] (Step S210).

The tag verification unit 250 determines whether or not the verification tag T* matches the authentication tag T (Step S220). When the verification tag T* matches the authentication tag T (Yes in Step S220), the tag verification unit 250 determines that the pair of the input vector V and the tag T is correct (Step S222). On the other hand, when the verification tag T* does not match the authentication tag T (No in Step S220), the tag verification unit 250 determines that the pair of the input vector V and the tag T has been forged (Step S224).

### <Effects>

Effects of the authentication system 1 according to the first example embodiment will be described. Although effects of the tag generation apparatus 10 will be described hereinafter, similar effects can also be achieved by the tag verification apparatus 20. This feature also applies to other example embodiments.

As described above, the tag generation apparatus 10 according to the first example embodiment concatenates a plurality of elements of an input vector V (input data), which consists of the plurality of elements, with one another and thereby generates a message M consisting of a single bit sequence Further, the tag generation apparatus 10 divides the message M into n-bit message blocks M[i]. Further, the tag generation apparatus 10 generates concatenation information D[i] (i.e., pieces of concatenation information D[i]), which correspond to the message blocks M[i], respectively, and are information about the concatenation of elements in the message block M[i]. Then, the tag generation apparatus 10 generates a tag by a block cipher by using the message blocks M[i] and the corresponding concatenation information D[i] (i.e., the corresponding pieces of concatenation information D[i]). In this way, the tag generation apparatus 10 according to the first example embodiment can efficiently generate a tag irrespective of the definition of the vector space. That is, the tag generation apparatus 10 according to the first example embodiment can efficiently generate a tag irrespective of the number of elements and the length of each of the elements of the input vector V (input data). Specifically, in the tag generation apparatus 10 according to the first example embodiment, the number of calls to the encryption function E_K, except for those required for the precomputation, can be made equal to the number of calls expressed by the above-shown Expression 3.

The previously-described method in which when the elements of an input vector V are concatenated with one another and a single bit sequence is thereby generated, len( ) indicating information about the length of each element is added after each element will be compared with the method according to the first example embodiment. In the method in which len( ) is added, the length of data input to the MAC is longer than the sum total of the bit lengths of the elements of the original vector by an amount expressed as |len( )|×(Number of elements). Specifically, when the length of len( ) for one element is expressed as c*n bits, the length of data input to the MAC is increased from the sum total of the bit lengths of the elements of the input vector V by an amount expressed as r*c*n bits. Note that a relation c∈(0, 1) holds, and r is the number of elements. In this case, the number of message blocks processed by the block cipher is increased from that in the case where a message obtained by simply concatenating the elements of an input vector V with one another is processed by the MAC by a number expressed as (r*c*n)/n=r*c (i.e., a number expressed as ceil (r*c)). Therefore, the number of calls to the encryption function E_K is increased from the number corresponding to the length of the message obtained by simply concatenating the elements of the input vector V with one another (the number shown by the above-shown Expression 3) by a number expressed as r*c.

In contrast, in the tag generation apparatus 10 according to the first example embodiment, the message processed by the MAC corresponds to what is obtained by simply concatenating the elements of an input vector V with one another. That is, the tag generation apparatus 10 according to the first example embodiment divides the message obtained by simply concatenating the elements of the input vector V with one another into message blocks each having n bits, and processes the divided message blocks by a block cipher. Therefore, in the method according to the first example embodiment, the number of calls to the encryption function E_K can be reduced from that in the above-described method in which len( ) is added by a number expressed as r*c. Further, since the value of r*c increases as the number of elements r increases, the reduction effect by the method according to the first example embodiment increases as the number of elements r increases. Therefore, in the method according to the first example embodiment, a tag can be efficiently generated.

Further, the length of len( ) is constant irrespective of the length of the element. Therefore, in the above-described method in which len( ) is added, when the number of elements is small, the relative length of len( ) to the element increases. Therefore, in the method according to the first example embodiment, as the number of elements become smaller, the relative number of calls to the encryption function E_K for the message obtained by simply concatenating the elements of the input vector V with one another can be more reduced compared with the above-described method in which len( ) is added. Specifically, for example, assume that the input vector V consists of n elements each having a length of one bit. In this case, while the length of the message obtained by simply concatenating the elements of the input vector V with one another is n bits, the length in the method in which len( ) is added increases therefrom by an amount expressed as |len( )|*n=c*n*n bits. In this case, while the number of calls to the encryption function E_K is only once in the method according to the first example embodiment, the number of calls to the encryption function E_K in the method in which len( ) is added increases therefrom by a number expressed as c*n. That is, in the method according to the first example embodiment, the number of calls to the encryption function E_K can be about 1/(1+c*n) of that in the method in which len( ) is added.

Further, for example, assume that the input vector V consists of n elements each having a length of n bits. In this case, while the length of the message obtained by simply concatenating the elements of the input vector V with one another is n*n bits, the length in the method in which len( ) is added increases therefrom by an amount expressed as |len( )|*n=c*n*n bits. In this case, while the number of calls to the encryption function E_K is n in the method according to the first example embodiment, the number of calls to the encryption function E_K in the method in which len( ) is added increases by a number expressed as c*n. That is, in the method according to the first example embodiment, the number of calls to the encryption function E_K can be about n/(n+c*n) of that in the method in which len( ) is added. Note that since a relation 1/(1+c*n)<n/(n+c*n) holds, it can be said that the reduction effect of the number of calls to the encryption function E_K in the method according to the first example embodiment increases as the number of short elements increases. Therefore, in the method according to the first example embodiment, a tag can be efficiently generated.

Further, in the method according to the first example embodiment, the presence of elements each consisting of an empty sequence does not affect the length of the message processed by the block cipher in the MAC. Therefore, in the method according to the first example embodiment, the presence of elements each consisting of an empty sequence does not affect the number of calls to the encryption function E_K. In other words, in the method according to the first example embodiment, even when the number of elements each consisting of an empty sequence increases, the number of calls to the encryption function E_K does not increase. In contrast, in the above-described method in which len( ) is added, len( ) having a predetermined length is added even to an element consisting of an empty sequence. Therefore, it can be said that compared with the method in which len( ) is added, the reduction effect of the number of calls to the encryption function E_K in the method according to the first example embodiment increases as the number of elements each consisting of an empty sequence increases. Therefore, in the method according to the first example embodiment, a tag can be efficiently generated.

Further, the method according to the second comparative example shown in FIG. 3 is compared with the method according to the first example embodiment. In the method according to the second comparative example, the encryption function E_K is called at least once even when the length of the element of the vector V is extremely shorter than n bits. Specifically, for example, assume that the number of elements of the vector V is n−1 and each of the elements consists of a 1-bit “0”, i.e., the vector V is expressed as V=(0, 0, . . . , 0). In the second comparative example, the encryption function E_K is called once even for an element consisting of one bit. Therefore, in the method according to the second comparative example, the encryption function E_K is called n−1 times for the above-described vector V.

In contrast, in the method according to the first example embodiment, the element V[1]∥V[2]∥ . . . ∥V[n−1] obtained by concatenating the elements with one another is processed by a block cipher. Note that the bit length of the element V[1]∥V[2]∥ . . . ∥V[n−1] is n−1 bits, i.e., is shorter than n. Therefore, in the method according to the first example embodiment, the encryption function E_K is called only once. Therefore, when the length of the element is short, the number of calls to the encryption function E_K in the method according to the first example embodiment can be reduced compared with that in the method according to the second comparative example. Further, in the method according to the second comparative example, the shorter the length of the element is, the longer the bit length added to the element of the vector by the padding process becomes. Therefore, the shorter the length of the element is, the more the reduction effect by the method according to the first example embodiment relative to that in the method according to the second comparative example increases. Therefore, in the method according to the first example embodiment, a tag can be efficiently generated.

Further, when the vector includes an element consisting of an empty sequence, the encryption function E_K needs to be called once even for this element in the second comparative example. In contrast, as described above, in the method according to the first example embodiment, the presence of elements each consisting of an empty sequence does not affect the length of the message processed by the block cipher in the MAC. Therefore, in the method according to the first example embodiment, even when the number of elements each consisting of an empty sequence increases, the number of calls to the encryption function E_K does not increase. Therefore, when the vector includes elements each consisting of an empty sequence, the number of calls to the encryption function E_K in the method according to the first example embodiment can be reduced compared with that in the method according to the second comparative example. Further, the larger the number of elements each consisting of an empty sequence is, the more the reduction effect by the method according to the first example embodiment increases. Therefore, in the method according to the first example embodiment, a tag can be efficiently generated.

Note that in the method according to the first example embodiment, it is necessary to perform precomputation (calculation of mask values and calculation of L required for the calculation of the mask values) in the method shown in FIGS. 8 to 10. Note that in the precomputation, it is necessary to call the encryption function E_K in order to calculate L. However, the number of calls to the encryption function E_K for the precomputation increases only in the order of ω+O(1). That is, the number of calls to the encryption function E_K in the precomputation does not depend on any of the number of elements, the length of the element, and the number of message blocks. Therefore, the precomputation does not significantly affect the efficiency of the tag generation.

Further, as described above, in the method according to the first example embodiment, message blocks are encrypted by using concatenation information. Therefore, even when message blocks identical to each other are encrypted, the results of the encryption of them differ from each other when their vectors differs from each other. Therefore, in the method according to the first example embodiment, tags can be securely generated. That is, in the method according to the first example embodiment, security (n/2 bit security) equivalent to those of the CMAC and PMAC described in the above-described Non-patent Literatures can be achieved.

Note that the format of the concatenation information is not limited to those shown in FIGS. 6 and 7. It is sufficient if the concatenation information generation unit 130 generates concatenation information so that delimiters of elements in the message block corresponding to the concatenation information can be determined based on the concatenation information. In other words, it is sufficient if the concatenation information generation unit 130 generates concatenation information so that the input vector (input data) can be uniquely reproduced from the concatenation information and the message block corresponding to the concatenation information. That is, it is sufficient if the concatenation information generation unit 130 generates concatenation information so that concatenation information (i.e., pieces of concatenation information) corresponding to message blocks for input vectors different from each other are different from each other even when the bit sequences of the message blocks obtained by concatenating the elements with one another are identical to each other.

For example, assume an input vector V expressed as V=(00, 01) and an input vector V′ expressed as V′=(0, 001). In this case, the input vectors V and V′ are vectors different from each other. However, messages M obtained by concatenating the elements of the input vectors V and V′ with one another are both expressed as M=0001. Therefore, the message blocks obtained from the input vectors V and V′ are the identical to each other. However, a delimiter of elements in the message block obtained from the input vector V is different from that in the message block obtained from the input vector V′. Therefore, concatenation information obtained from the input vector V can be different from concatenation information obtained from the input vector V′. By generating such concatenation information, the method according to the first example embodiment can achieve the security of n/2 bit security as described above.

Further, as described above, in the method shown in FIGS. 8 to 10, the mask value Δ is generated by the encryption function E_K by using the concatenation information. Note that as described above, L_j can be calculated by the precomputation and stored in the memory. Therefore, in the first example embodiment, when message blocks are processed, it is possible to eliminate the need for calls to the encryption function E_K, except for calls to the encryption function E_K that are performed in order to encrypt the message blocks.

Further, when an input vector is provided, the concatenation information generation unit 130 can uniquely generate concatenation information (i.e., pieces of concatenation information) corresponding to message blocks obtained from the input vector. Note that in order to shorten the processing time of the MAC, it is desirable that the processing of the MAC is performed in a successive manner even when input vectors are successively input. That is, even when input vectors are successively input, it is desirable that the message blocks are successively processed by the encryption function E_K. In this case, it is necessary to successively generate concatenation information (i.e., pieces of concatenation information) without waiting until the whole input vectors are input. Note that as described above, the concatenation information generation unit 130 may perform processing in such a manner that every time one of the elements of an input vector is input, it sums up the lengths of the input elements, and every time the sum total of the lengths becomes n bits, it extracts the position at which the elements are changed in the n bits. By performing such processing, the concatenation information generation unit 130 can successively generate concatenation information (i.e., pieces of concatenation information). Therefore, the tag generation apparatus 10 according to the first example embodiment can efficiently generate a tag in terms of the processing time of the MAC.

### Second Example Embodiment

Next, a second example embodiment will be described. The second example embodiment corresponds to an outline of the configuration according to the first example embodiment.

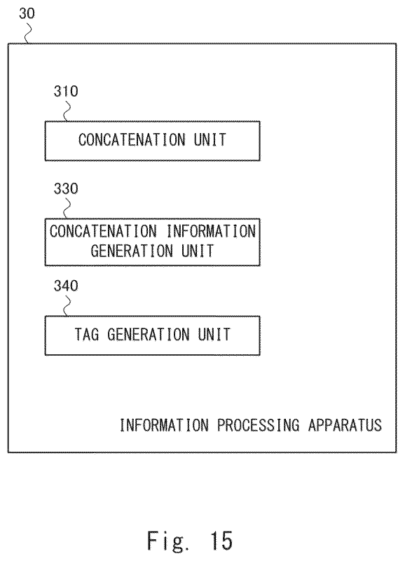

FIG. 15 shows a configuration of an information processing apparatus 30 according to the present disclosure. The information processing apparatus 30 corresponds to the above-described tag generation apparatus 10 and the tag verification apparatus 20. The information processing apparatus 30 includes a concatenation unit 310, a concatenation information generation unit 330, and a tag generation unit 340.

The concatenation unit 310 functions as concatenation means. The concatenation information generation unit 330 functions as concatenation information generation means. The tag generation unit 340 functions as tag generation means.

The concatenation unit 310 may be implemented by functions substantially the same as those of the above-described concatenation unit 110 and the concatenation unit 210. The concatenation information generation unit 330 may be implemented by functions substantially the same as those of the above-described concatenation information generation unit 130 and the concatenation information generation unit 230. The tag generation unit 340 may be implemented by functions substantially the same as those of the above-described tag generation unit 140 and the tag generation unit 240.

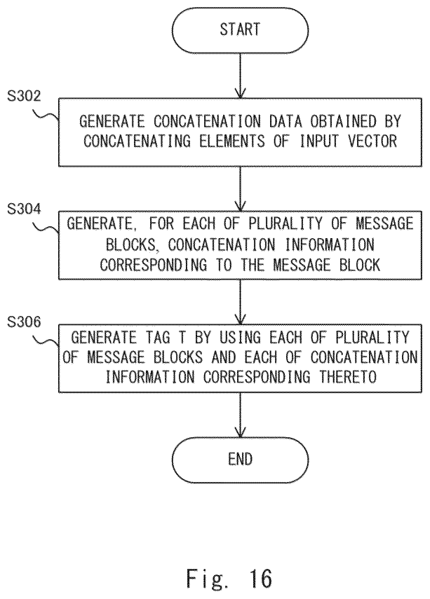

FIG. 16 is a flowchart showing an information processing method implemented by the information processing apparatus 30 according to the present disclosure. Note that FIG. 16 shows a tag generation method implemented by the information processing apparatus 30 according to the present disclosure.

The concatenation unit 310 generates concatenation data obtained by concatenating the elements of input data with one another (Step S302). The concatenation information generation unit 330 generates, for each of the plurality of message blocks, concatenation information (i.e., a piece of concatenation information) corresponding to the message block (Step S304). Specifically, the concatenation information generation unit 330 generates, for each of a plurality of message blocks obtained by dividing concatenation data into blocks each having a predetermined data length, concatenation information (i.e., a piece of concatenation information) about the concatenation of the elements in the message block. The tag generation unit 340 generates a tag by using each of the plurality of message blocks and each of the concatenation information (i.e., the pieces of concatenation information) corresponding to the respective message blocks (Step S306). Specifically, the tag generation unit 340 generates a tag for a message authentication code by a block cipher by using each of the plurality of message blocks and each of the concatenation information (i.e., the pieces of concatenation information) corresponding to the respective message blocks. Note that in the block cipher, a message having a predetermined data length, which is the data length of a message block, is used as an input.

The information processing apparatus 30 according to the second example embodiment are configured as described above, and therefore can provide effects substantially the same as those of the tag generation apparatus 10 and the tag verification apparatus 20 according to the first example embodiment. That is, the information processing apparatus 30 according to the second example embodiment can efficiently generate a tag irrespective of the definition of the vector space. That is, the information processing apparatus 30 according to the second example embodiment can efficiently generate a tag irrespective of the number of elements and the length of each of the elements of the input vector V (input data). Specifically, in the information processing apparatus 30 according to the second example embodiment, the number of calls to the block cipher (encryption function E_K), except for those required for the precomputation, can be made equal to the number of calls expressed by the above-shown Expression 3.

### Example of Hardware Configuration

An example of a configuration of hardware resources for implementing an apparatus and a system according to the above-described example embodiment by using one calculation processing apparatus (an information processing apparatus or a computer) will be described. However, the apparatus according to any of the example embodiments (authenticated encryption apparatus and authenticated decryption apparatus) may be physically or functionally implemented by using at least two calculation processing apparatus. Further, the apparatus according to any of the example embodiments may be implemented as a dedicated apparatus or as a general-purpose information processing apparatus.

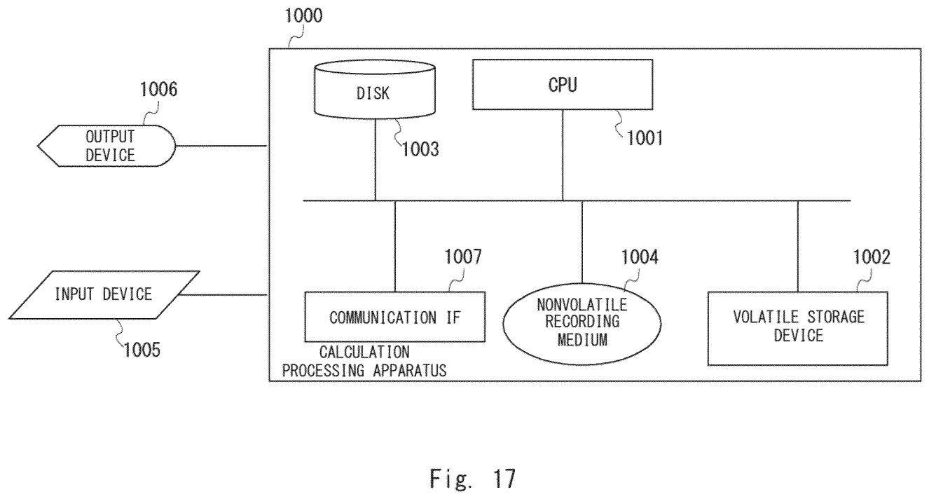

FIG. 17 is a block diagram schematically showing an example of a hardware configuration of a calculation processing apparatus 1000 capable of implementing an apparatus and a system according to the present disclosure. A calculation processing apparatus 1000 includes a CPU 1001, a volatile storage device 1002, a disk 1003, a nonvolatile recording medium 1004, and a communication IF (IF: Interface) 1007. Therefore, it can be said that the apparatus according to any of the example embodiments includes the CPU 1001, the volatile storage device 1002, the disk 1003, the nonvolatile recording medium 1004, and the communication IF 1007. The calculation processing apparatus 1000 may be configured so that it can be connected to an input device 1005 and an output device 1006. The calculation processing apparatus 1000 may include the input device 1005 and the output device 1006. Further, the calculation processing apparatus 1000 may transmit/receive information to/from other calculation processing apparatuses and communication apparatuses through the communication IF 1007.

The nonvolatile recording medium 1004 is, for example, a computer readable CD (Compact Disc) or a computer readable DVD (Digital Versatile Disc). Further, the nonvolatile recording medium 1004 may be a USB (Universal Serial Bus) memory, an SSD (Solid State Drive), or the like. The nonvolatile recording medium 1004 holds (i.e., retains) a relevant program(s) even when no electric power is supplied, thus enabling the program(s) to be carried and transported. Note that the nonvolatile recording medium 1004 is not limited to the above-described media. Further, Alternatively, instead of using the nonvolatile recording medium 1004, the relevant program(s) may be supplied through the communication IF 1007 and a communication network(s).

The volatile storage device 1002 can be read by a computer, and can temporarily store data. The volatile storage device 1002 is a memory or the like such as a DRAM (dynamic random access memory) or an SRAM (static random access memory).

That is, the CPU 1001 copies (i.e., loads) a software program (a computer program: hereinafter also simply referred to as a “program”) stored in the disc 1003 into the volatile storage device 1002 when it performs the program, and thereby performs arithmetic processing. The CPU 1001 reads data necessary for executing the program from the volatile storage device 1002. When it is necessary to display an output result, the CPU 1001 displays the output result on the output device 1006. When a program is input from the outside, the CPU 1001 acquires the program through the input device 1005. The CPU 1001 interprets and executes programs corresponding to the above-described functions (the processes) of the respective components shown in FIGS. 5, 12 and 15. The CPU 1001 performs the processes described in each of the above-described example embodiments. In other words, the above-described functions of the respective components shown in FIGS. 5, 12 and 15 can be implemented by having the CPU 1001 execute a program(s) stored in the disc 1003 or the volatile storage device 1002.

That is, it can be considered that each example embodiment can be accomplished by the above-described program. Further, it can be considered that each of the above-described example embodiments can also be accomplished by a nonvolatile recording medium which can be read by a computer and in which the above-described program is recorded.

### Modified Example

Note that the present invention is not limited to the above-described example embodiments, and they may be modified as appropriate without departing from the scope and spirit of the invention. For example, in the above-described flowcharts, the order of processes (Steps) can be changed as appropriate. Further, at least one of a plurality of processes (Steps) may be omitted (or skipped). Further, the above-described plurality of example embodiments can be applied to each other.

In the example embodiments described above, examples in which input data processed by the MAC is vector data is shown, but the configuration according to the present disclosure is not limited such configurations. The input data may not be vector data as long as it is data consisting of a plurality of elements. Further, the input data consisting of a plurality of elements may include no element consisting of an empty sequence.

Although the present disclosure has been described above with reference to example embodiments, the present disclosure is not limited to the above-described example embodiments. Various modifications that can be understood by those skilled in the art can be made to the configuration and details of the present disclosure within the scope of the disclosure. Further, each of the example embodiments can be combined with any of other example embodiments as appropriate.

Each of the drawings is merely an example to illustrate one or more embodiments. Each of the drawing is not associated with only one specific embodiment, but may be associated with one or more other embodiments. As will be understood by those skilled in the art, various features or steps described with reference to any one of the drawings may be combined with features or steps shown in one or more other drawings in order to create, for example, an embodiment that is not explicitly shown in the drawings or described in the specification. Not all of the features or steps shown in any one of the drawings to describe an embodiment are necessarily indispensable, and some features or steps may be omitted. The order of steps in any of the drawings may be changed as appropriate.

The above-described program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (Registered Trademark) disk or other optical disk storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

The whole or part of the example embodiments disclosed above can be described as, but not limited to, the following supplementary notes.

### (Supplementary Note 1)

An information processing apparatus comprising:
concatenation means for generating concatenation data obtained by concatenating a plurality of elements of input data consisting of the plurality of elements with one another;
concatenation information generation means for generating, for each of a plurality of message blocks obtained by dividing the concatenation data into blocks each having a predetermined data length, concatenation information about the concatenation of the elements in the message block; and
tag generation means for generating a tag for a message authentication code by a block cipher by using each of the plurality of message blocks and each of the concatenation information corresponding to the respective message blocks, the block cipher being a cipher of which an input is a message having the predetermined data length.

### (Supplementary Note 2)

The information processing apparatus described in Supplementary note 1, wherein the tag generation means generates the tag by generating a plurality of random numbers corresponding to the respective message blocks by the block cipher by using the concatenation information corresponding to the respective message blocks.

### (Supplementary Note 3)

The information processing apparatus described in Supplementary note 2, wherein the tag generation means generates the tag by encrypting each of the plurality of message blocks by the block cipher by using the concatenation information corresponding to the message block.

### (Supplementary Note 4)

The information processing apparatus described in Supplementary note 3, wherein the tag generation means generates the tag by encrypting each of the plurality of message blocks by a Tweakable block cipher using the concatenation information corresponding to the message block as a Tweak.

### (Supplementary Note 5)

The information processing apparatus described in Supplementary note 4, wherein the tag generation means generates the tag by encrypting each of the plurality of message blocks by a Tweakable block cipher using the concatenation information corresponding to the message block as a Tweak, and performing a process for adding an obtained encryption result to a next message block.

### (Supplementary Note 6)

The information processing apparatus described in Supplementary note 4, wherein the tag generation means generates the tag by encrypting the plurality of message blocks in parallel with each other by Tweakable block ciphers in which the concatenation information corresponding to the respective message blocks and indices of the message blocks are used as Tweaks, and adding obtained encryption results.

### (Supplementary Note 7)

The information processing apparatus described in Supplementary note 2, wherein the tag generation means generates the tag by encrypting each of the plurality of message blocks by the block cipher and converting each of obtained encryption results using the concatenation information corresponding to the message block.

### (Supplementary Note 8)

The information processing apparatus described in Supplementary note 1, wherein the concatenation information generation means generates the concatenation information so that a delimiter of elements in the message block corresponding to the concatenation information can be determined based on the concatenation information.

### (Supplementary Note 9)

The information processing apparatus described in Supplementary note 8, wherein the concatenation information indicates at least a position at which elements are connected with each other in each of the plurality of message blocks.

### (Supplementary Note 10)

The information processing apparatus described in Supplementary note 9, wherein the concatenation information indicates a position of each element which is an empty sequence and a number thereof in each of the message blocks.

### (Supplementary Note 11)

The information processing apparatus described in Supplementary note 9, wherein the concatenation information indicates at least a position at which elements are connected with each other for each position at which elements can be concatenated with each other in each of the plurality of the message blocks.

### (Supplementary Note 12)

The information processing apparatus described in Supplementary note 11, wherein the concatenation information indicates a position of each element which is an empty sequence and a number thereof for each position at which elements can be concatenated with each other in each of the plurality of the message blocks.

### (Supplementary Note 13)

The information processing apparatus described in Supplementary note 1, wherein the concatenation information generation means successively generates the concatenation information when input data is successively input.

### (Supplementary Note 14)

An information processing method comprising:
generating concatenation data obtained by concatenating a plurality of elements of input data consisting of the plurality of elements with one another;
generating, for each of a plurality of message blocks obtained by dividing the concatenation data into blocks each having a predetermined data length, concatenation information about the concatenation of the elements in the message block; and
generating a tag for a message authentication code by a block cipher by using each of the plurality of message blocks and each of the concatenation information corresponding to the respective message blocks, the block cipher being a cipher of which an input is a message having the predetermined data length.

### (Supplementary Note 15)

The information processing method described in Supplementary note 14, wherein the tag is generated by generating a plurality of random numbers corresponding to the respective message blocks by the block cipher by using the concatenation information corresponding to the respective message blocks.

### (Supplementary Note 16)

The information processing method described in Supplementary note 15, wherein the tag is generated by encrypting each of the plurality of message blocks by the block cipher by using the concatenation information corresponding to the message block.

### (Supplementary Note 17)

The information processing method described in Supplementary note 16, wherein the tag is generated by encrypting each of the plurality of message blocks by a Tweakable block cipher using the concatenation information corresponding to the message block as a Tweak.

### (Supplementary Note 18)

The information processing method described in Supplementary note 17, wherein the tag is generated by encrypting each of the plurality of message blocks by a Tweakable block cipher using the concatenation information corresponding to the message block as a Tweak, and performing a process for adding an obtained encryption result to a next message block.

### (Supplementary Note 19)

The information processing method described in Supplementary note 17, wherein the tag is generated by encrypting the plurality of message blocks in parallel with each other by Tweakable block ciphers in which the concatenation information corresponding to the respective message blocks and indices of the message blocks are used as Tweaks, and adding obtained encryption results.

### (Supplementary Note 20)

The information processing method described in Supplementary note 15, wherein the tag is generated by encrypting each of the plurality of message blocks by the block cipher and converting each of obtained encryption results using the concatenation information corresponding to the message block.

### (Supplementary Note 21)

The information processing method described in Supplementary note 14, wherein the concatenation information is generated so that a delimiter of elements in the message block corresponding to the concatenation information can be determined based on the concatenation information.

### (Supplementary Note 22)

The information processing method described in Supplementary note 21, wherein the concatenation information indicates at least a position at which elements are connected with each other in each of the plurality of message blocks.

### (Supplementary Note 23)

The information processing method described in Supplementary note 22, wherein the concatenation information indicates a position of each element which is an empty sequence and a number thereof in each of the message blocks.

### (Supplementary Note 24)

The information processing method described in Supplementary note 22, wherein the concatenation information indicates at least a position at which elements are connected with each other for each position at which elements can be concatenated with each other in each of the plurality of the message blocks.

### (Supplementary Note 25)

The information processing method described in Supplementary note 24, wherein the concatenation information indicates a position of each element which is an empty sequence and a number thereof for each position at which elements can be concatenated with each other in each of the plurality of the message blocks.

### (Supplementary Note 26)

The information processing method described in Supplementary note 14, wherein the concatenation information is successively generated when input data is successively input.

### (Supplementary Note 27)

A program for causing a computer to perform:
a step of generating concatenation data obtained by concatenating a plurality of elements of input data consisting of the plurality of elements with one another;
a step of generating, for each of a plurality of message blocks obtained by dividing the concatenation data into blocks each having a predetermined data length, concatenation information about the concatenation of the elements in the message block; and
a step of generating a tag for a message authentication code by a block cipher by using each of the plurality of message blocks and each of the concatenation information corresponding to the respective message blocks, the block cipher being a cipher of which an input is a message having the predetermined data length.

### (Supplementary Note 28)

The program described in Supplementary note 27, further causing the computer to perform a step of generating a tag by generating a plurality of random numbers corresponding to the respective message blocks by the block cipher by using the concatenation information corresponding to the respective message blocks.

### (Supplementary Note 29)

The program described in Supplementary note 28, further causing the computer to perform a step of generating a tag by encrypting each of the plurality of message blocks by the block cipher by using the concatenation information corresponding to the message block.

### (Supplementary Note 30)

The program described in Supplementary note 29, further causing the computer to perform a step of generating a tag by encrypting each of the plurality of message blocks by a Tweakable block cipher using the concatenation information corresponding to the message block as a Tweak.

### (Supplementary Note 31)

The program described in Supplementary note 30, further causing the computer to perform a step of generating a tag by encrypting each of the plurality of message blocks by a Tweakable block cipher using the concatenation information corresponding to the message block as a Tweak, and performing a process for adding an obtained encryption result to a next message block.

### (Supplementary Note 32)

The program described in Supplementary note 30, further causing the computer to perform a step of generating a tag by encrypting the plurality of message blocks in parallel with each other by Tweakable block ciphers in which the concatenation information corresponding to the respective message blocks and indices of the message blocks are used as Tweaks, and adding obtained encryption results.

### (Supplementary Note 33)

The program described in Supplementary note 28, further causing the computer to perform a step of generating a tag by encrypting each of the plurality of message blocks by the block cipher and converting each of obtained encryption results using the concatenation information corresponding to the message block.

### (Supplementary Note 34)

The program described in Supplementary note 27, wherein further causing the computer to perform a step of generating the concatenation information so that a delimiter of elements in the message block corresponding to the concatenation information can be determined based on the concatenation information.

### (Supplementary Note 35)

The program described in Supplementary note 34, wherein the concatenation information indicates at least a position at which elements are connected with each other in each of the plurality of message blocks.

### (Supplementary Note 36)

The program described in Supplementary note 35, wherein the concatenation information indicates a position of each element which is an empty sequence and a number thereof in each of the message blocks.

### (Supplementary Note 37)

The program described in Supplementary note 35, wherein the concatenation information indicates at least a position at which elements are connected with each other for each position at which elements can be concatenated with each other in each of the plurality of the message blocks.

### (Supplementary Note 38)

The program described in Supplementary note 37, wherein the concatenation information indicates a position of each element which is an empty sequence and a number thereof for each position at which elements can be concatenated with each other in each of the plurality of the message blocks.

### (Supplementary Note 39)

The program described in Supplementary note 27, further causing the computer to perform a step of successively generating the concatenation information when input data is successively input.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An information processing apparatus comprising:
at least one memory configured to store instructions; and
at least one processor configured to execute the instructions to:
generate concatenation data obtained by concatenating a plurality of elements of input data consisting of the plurality of elements with one another;
generate, for each of a plurality of message blocks obtained by dividing the concatenation data into blocks each having a predetermined data length, concatenation information about the concatenation of the elements in the message block; and
generate a tag for a message authentication code by a block cipher by using each of the plurality of message blocks and each of the concatenation information corresponding to the respective message blocks, the block cipher being a cipher of which an input is a message having the predetermined data length.

2. The information processing apparatus according to claim 1, wherein the at least one processor is further configured to execute the instructions to generate the tag by generating a plurality of random numbers corresponding to the respective message blocks by the block cipher by using the concatenation information corresponding to the respective message blocks.

3. The information processing apparatus according to claim 2, wherein the at least one processor is further configured to execute the instructions to generate the tag by encrypting each of the plurality of message blocks by the block cipher by using the concatenation information corresponding to the message block.

4. The information processing apparatus according to claim 3, wherein the at least one processor is further configured to execute the instructions to generate the tag by encrypting each of the plurality of message blocks by a Tweakable block cipher using the concatenation information corresponding to the message block as a Tweak.

5. The information processing apparatus according to claim 4, wherein the at least one processor is further configured to execute the instructions to generate the tag by encrypting each of the plurality of message blocks by a Tweakable block cipher using the concatenation information corresponding to the message block as a Tweak, and performing a process for adding an obtained encryption result to a next message block.

6. The information processing apparatus according to claim 4, wherein the at least one processor is further configured to execute the instructions to generate the tag by encrypting the plurality of message blocks in parallel with each other by Tweakable block ciphers in which the concatenation information corresponding to the respective message blocks and indices of the message blocks are used as Tweaks, and adding obtained encryption results.

7. The information processing apparatus according to claim 2, wherein the at least one processor is further configured to execute the instructions to generate the tag by encrypting each of the plurality of message blocks by the block cipher and converting each of obtained encryption results using the concatenation information corresponding to the message block.

8. The information processing apparatus according to claim 1, wherein the at least one processor is further configured to execute the instructions to generate the concatenation information so that a delimiter of elements in the message block corresponding to the concatenation information can be determined based on the concatenation information.

9. The information processing apparatus according to claim 8, wherein the concatenation information indicates at least a position at which elements are connected with each other in each of the plurality of message blocks.

10. The information processing apparatus according to claim 9, wherein the concatenation information indicates a position of each element which is an empty sequence and a number thereof in each of the message blocks.

11. The information processing apparatus according to claim 9, wherein the concatenation information indicates at least a position at which elements are connected with each other for each position at which elements can be concatenated with each other in each of the plurality of the message blocks.

12. The information processing apparatus according to claim 11, wherein the concatenation information indicates a position of each element which is an empty sequence and a number thereof for each position at which elements can be concatenated with each other in each of the plurality of the message blocks.

13. The information processing apparatus according to claim 1, wherein the at least one processor is further configured to execute the instructions to successively generate the concatenation information when input data is successively input.

14. An information processing method comprising:
generating concatenation data obtained by concatenating a plurality of elements of input data consisting of the plurality of elements with one another;
generating, for each of a plurality of message blocks obtained by dividing the concatenation data into blocks each having a predetermined data length, concatenation information about the concatenation of the elements in the message block; and
generating a tag for a message authentication code by a block cipher by using each of the plurality of message blocks and each of the concatenation information corresponding to the respective message blocks, the block cipher being a cipher of which an input is a message having the predetermined data length.

15. The information processing method according to claim 14, wherein the tag is generated by generating a plurality of random numbers corresponding to the respective message blocks by the block cipher by using the concatenation information corresponding to the respective message blocks.

16. The information processing method according to claim 15, wherein the tag is generated by encrypting each of the plurality of message blocks by the block cipher by using the concatenation information corresponding to the message block.

17. The information processing method according to claim 16, wherein the tag is generated by encrypting each of the plurality of message blocks by a Tweakable block cipher using the concatenation information corresponding to the message block as a Tweak.

18. The information processing method according to claim 17, wherein the tag is generated by encrypting each of the plurality of message blocks by a Tweakable block cipher using the concatenation information corresponding to the message block as a Tweak, and performing a process for adding an obtained encryption result to a next message block.

19. The information processing method according to claim 17, wherein the tag is generated by encrypting the plurality of message blocks in parallel with each other by Tweakable block ciphers in which the concatenation information corresponding to the respective message blocks and indices of the message blocks are used as Tweaks, and adding obtained encryption results.

20. A non-transitory computer readable medium storing a program for causing a computer to perform:
a step of generating concatenation data obtained by concatenating a plurality of elements of input data consisting of the plurality of elements with one another;
a step of concatenation information generation means for generating, for each of a plurality of message blocks obtained by dividing the concatenation data into blocks each having a predetermined data length, concatenation information about the concatenation of the elements in the message block; and
a step of tag generation means for generating a tag for a message authentication code by a block cipher by using each of the plurality of message blocks and each of the concatenation information corresponding to the respective message blocks, the block cipher being a cipher of which an input is a message having the predetermined data length.
